(19) United States
(12) Patent Application Publication
(10) Pub. No.: US 2005/0063851 A1
(43) Pub. Date: Mar. 24, 2005

(54) Gerotor pumps and methods of manufacture therefor

(76) Inventor: Edward H Phillips, Long Lake Road, MI (US)

Correspondence Address: Thomas E Anderson;Gifford Krass Groh Sprinkle Anderson & Citkowski, 280 N Old Woodward Avenue, Suite 400, Birmingham, MI, 48009, US

(21) Appl. No.: 10/498,663

(22) PCT Filed: Dec. 11, 2002
(86) PCT No.: PCT/US02/39812

Related U.S. Application Data
(60) Provisional application No. 60/341,510, filed on Dec. 13, 2001.
(60) Provisional application No. 60/349,770, filed on Jan. 18, 2002.

(51) Int. Cl. F01C 1/02; F03C 2/00

(52) U.S. Cl. 418/61.3; 418/133; 418/73

(57) ABSTRACT

Improved gerotor pumps (10, 100, 150, 180, 210, 230, 260, 270, 310, 340, 370, 400) each featuring an outer rotor (18, 184, 202) of a gerotor set (12, 186, 204, 344) located laterally with respect to a preferred eccentricity axis (54), but allowed to float in the orthogonal direction nominally along the preferred eccentricity axis and find its own eccentricity offset rotation axis (5440 ) via mesh of the gerotor set itself are provided in the present invention. Reduced gerotor set operating clearances for the gerotor sets, and therefore higher attained output pressure values, are attained by utilization of any of methods also presented for reforming tip regions of either or both of the inner and outer rotors.

### BACKGROUND OF THE INVENTION

I. Field of the Invention

The present invention relates generally to gerotor pumps, and more particularly to improved gerotor pumps wherein outer rotors are enabled for finding their own eccentricity offset axes, and furthermore, to improved methods of manufacture for preferred gerotor gear sets to be utilized therein.

II. Description of the Prior Art

Gerotor pumps are most conveniently designed around commercially available gerotor gear sets (hereinafter simply “gerotor sets”) such as those manufactured by Nichols Portland of Portland, Me. Such gerotor sets comprise an inner rotor having N outwardly extending lobes with N approximately circularly shaped grooves therebetween (i.e., with N typically having values of 4, 6, 8 or 10) in mesh with an eccentrically disposed outer rotor comprising N+1 inwardly extending circularly shaped elements. Generally, the inner rotor is mounted upon and driven by a shaft drivingly coupled to the drive shaft of a prime mover such as an electric motor. The eccentrically disposed outer rotor is then driven by the inner rotor via meshing of the outwardly and inwardly extending lobes instantly located nearest an “in-mesh” position. This meshing contact occurs with near zero relative velocity between inner and outer rotors in the region of the in-mesh position while a maximum relative velocity between tips of the outwardly extending lobes of the inner rotor and the inwardly extending lobes of the outer rotor occurs at the opposite or out-of-mesh position along an eccentricity axis.

Present art gerotor pumps comprise a fixedly positioned eccentric gerotor pocket within which the outer rotor is supported by a hydrodynamic bearing. In most gerotor pumps the gerotor pocket is simply formed as part of the pump housing and then completed by a cover plate wherein inner surfaces of the gerotor pocket and cover plate serve as first and second sides of a gerotor cavity. In high pressure gerotor pumps however, the eccentric gerotor pocket is generally formed in a center plate with first and second sides of the eccentric gerotor cavity being provided by the facing surfaces of the housing and cover plate. This is done in order to more adequately control axially directed tolerances and resulting part clearances between the gerotor set and the facing surfaces of the housing and cover plate. In either case, the bore of the eccentric gerotor cavity is formed about a preferred eccentricity offset rotation axis located along a preferred eccentricity axis at a distance nominally equal to a gear addendum. Axially oriented symmetrical fluid commutation ports are formed in either or both of the first and second sides of the gerotor cavity to either side of the preferred eccentricity axis and are fluidly coupled to housing ports.

In operation, fluid is conveyed from the inlet fluid commutation port to inlet side ones of N+1 pumping chambers formed between the outwardly and inwardly extending lobes and elements as they move out of mesh on the inlet side, and then out the outlet fluid commutation port via outlet side ones of the N+1 pumping chambers as they move back toward mesh on the outlet side. The pumping chambers are formed between N nominal line seals provided by the mesh of the outwardly and inwardly extending lobes and elements and an additional nominal line seal between one inwardly extending element and a juxtaposed one of the grooves of the inner rotor nearest the “in-mesh” position. Thus, fluid entering via the inlet fluid commutation port is conveyed to the outlet fluid commutation port at a pressure value determined by the system load via each of the sequentially moving ones of the N+1 pumping chambers. Interestingly, the shaft must rotate (N+1)/N revolutions for a complete cycle of any of the N+1 pumping chambers.

Transverse loading between the inner rotor and outer rotor is nominally generated by the product of the difference between the output and input pressures, and the net transverse plan area between instant ones of the sealing lines formed nearest to the “in” and “out” of mesh positions. Normally, the outer rotor is directly supported by the hydrodynamic bearing formed between it and the eccentric housing bore as described above. Alternately, a needle bearing could be used to support the outer rotor for a gerotor pump that rotates at too low a speed to generate sufficient hydrodynamic bearing support.

Shaft support bearings are often utilized on either side of the inner rotor to support oppositely directed equal transverse loading of the inner rotor in present art gerotor pumps subject to relatively high pressure system loads. Because such shaft support bearings are mounted in both of the housing and cover plate, this in turn requires that the housing and cover plate be positioned in line with one another in a precision manner.

Because the axes of rotation of the gerotor pump and prime mover drive shafts are each fixedly located, the rotational axis of the gerotor pump shaft cannot in general be truly co-axial with the prime mover drive shaft. This requires separate shafts drivingly coupled one-to-another by a compliant coupling. In addition, such gerotor pumps are generally provided with a shaft seal in order to retain the fluid within the pump itself thus tending to make a long and rather complex assembly of the resulting prime mover/coupling/gerotor pump assembly. In addition, the housing, center plate and cover plate must all have precision alignment features for aligning the two gerotor pump bearings along the preferred shaft rotation axis. Further, the gerotor pocket formed in the center plate must be precisely located about the preferred eccentricity offset rotation axis in order to allow proper meshing of the gerotor set.

In general, it would be desirable to provide gerotor pumps having an additional degree of freedom whereby the outer rotor could find its own optimum center of rotation under all conditions of loading and shaft deflection. This would allow significant simplification whereby the resulting gerotor pump could be directly driven by a drive motor output shaft without any of the above described bearings, shaft coupling and additional extreme precision location features.

In addition to all of the above, it is difficult to form and maintain proper clearance values between the gerotor set and the first and second sides of the gerotor cavity of a gerotor pump configured for high pressure system loads (i.e., as determined by the difference in gerotor set thickness and effective center plate thickness). This is due to such practical details as difficulties in maintaining adequate dimensional control of the thickness of the center plate as well as associated contamination resulting from utilization of required interfacing surface sealing means (i.e., such as compliant shims or O-rings). It would be desirable to provide inherently simpler internal means for determining an appropriate minimal axial clearance between the gerotor set and the first and second sides of the gerotor cavity.

Finally, although the Nichols Portland catalog states “all gerotor sets share the basic principle of having conjugately-generated tooth profiles which provide continuous fluid-tight sealing during operation”, the “tooth” (and groove) profiles of the inner rotor are not “conjugately-generated” with respect to the “tooth” profiles of the outer rotor. Rather, the inner and outer rotors of all present art gerotor sets are separately manufactured. Most are economically formed in high volume via utilization of powdered metal technology. Such gerotor sets commonly attain diametral lobe-to-lobe and lobe-to-groove clearances of perhaps 0.003 inch. Although the attainment of such diametral clearance values is in fact an outstanding example of the use of powdered metal technology, those clearances are simply too large for efficient utilization in pumps generating pressure values beyond a few hundreds of pounds per square inch. This is because of “tip leakage” across critical differential pressure bearing nominal contact points (hereinafter “contact points”).

Because of the factors presented above, present art gerotor sets used in pumps intended for higher pressures such as 2,000 PSI are generally formed of case hardening alloy steels. They are hardened and precision ground in order to attain diametral clearance between the critical lobe-to-lobe and lobe-to-groove contact points in the range of perhaps 0.0005 to 0.001 inch. Although this method of manufacture has proven successful in attaining the required accuracy for gerotor sets intended for high-pressure utilization, it is expensive and therefore deemed unsuitable for high volume applications. It would be desirable to provide methods whereby tip portions of lobes of gerotor sets that actually define the critical in- and out-of-mesh position contact points can be re-contoured so as to economically achieve the preferred diametral clearance values of 0.0005 to 0.001 inch between the critical out-of-mesh and lobe-to-groove contact points.

Therefore, it is a general object of the present invention to provide improved gerotor pumps having an additional degree of freedom whereby outer rotors thereof can find their own optimum centers of rotation, and further, wherein fewer precision parts and precision location features are required. It is a further object of the present invention to provide internal means for setting required minimal axial clearance between the gerotor set and the first and second sides of the gerotor cavities of such gerotor pumps. It is still another object of the present invention to provide re-contouring methods whereby the tip portions of lobes of resulting preferred gerotor sets can be re-contoured in order to economically achieve the preferred diametral clearance values of 0.0005 to 0.001 inch between the critical lobe-to-lobe and lobe-to-groove contact points thus enabling utilization of such preferred gerotor sets in high-pressure gerotor pumps. Furthermore, additional objects of the present invention include implementing reduced friction between inner and outer rotor elements of the improved gerotor pumps as well as providing improved porting configurations and improved port timing in and for the improved gerotor pumps.

### SUMMARY OF THE INVENTION

These and other objects are achieved in improved gerotor pumps according to preferred embodiments of the present invention. Similarly to present art gerotor pumps, an inner rotor of a gerotor set having N outwardly extending lobes with N approximately circularly shaped grooves therebetween is directly driven from a drive motor's output shaft (hereinafter “the drive shaft”). The inner rotor then drives an outer rotor of the gerotor set having N+1 inwardly extending circularly shaped elements about a preferred eccentricity offset rotation axis located generally along a preferred eccentricity axis. However, in each of the improved gerotor pump embodiments of the present invention, the outer rotor is located laterally within the gerotor pocket by lateral constraining means but allowed to float in the orthogonal direction whereby the distance to an actual eccentricity offset rotation axis is determined by the mesh of the gerotor set itself. The lateral constraining means support transverse loading between the inner and outer rotor as nominally generated by the product of the difference between the output and input pressures, and the net transverse plan area between instant ones of the sealing lines formed nearest to the “in” and “out” of mesh positions (hereinafter more simply referred to as “transverse loading”). Then either the drive shaft, or alternately an axle utilized in a universal gerotor pump described below in a seventh alternate preferred embodiment, support equal and oppositely directed transverse loading.

In a preferred embodiment of the present invention, the outer rotor is located laterally by directly rolling on a cam follower disposed laterally outside the outer rotor on the same side of the preferred eccentricity offset rotation axis as the higher-pressure one of the axially oriented fluid commutation ports. In the event that a gerotor pump configured according to the preferred embodiment is to be subjected to bi-directional delivery pressure, first and second cam followers are provided and are disposed laterally in both directions from the preferred eccentricity offset rotation axis. In a slightly modified version of the preferred embodiment of the present invention suitable for use in unidirectional gerotor pumps, the cam follower is replaced by an adjustable eccentric cam follower whereby the operative lateral position of the outer rotor can be adjusted. This version of the improved gerotor pump can be mounted on a drive motor, run under desired output delivery conditions and then adjusted for smoothest running and minimum pump noise.

Thus, a first improved method of supporting a gerotor set comprised in a gerotor pump has been enabled by the preferred embodiment of the present invention. This method comprises the steps of locating the outer rotor of a gerotor set laterally with reference to a preferred eccentricity axis of a gerotor pump, and allowing the outer rotor to find its own eccentricity offset rotation axis location via the mesh of the gerotor set itself.

In alternate preferred embodiments of the present invention, the outer rotor is located within a floating ring that is in turn located laterally with respect to the preferred eccentricity axis but allowed to float nominally along the preferred eccentricity axis. Thus, the position of the floating ring in the orthogonal direction is determined via allowing the mesh of the outer rotor of the gerotor set to determine its own orthogonal location via meshing action, and therefore, the orthogonal location of the floating ring as well.

In a first alternate preferred embodiment of the present invention, the floating ring is located laterally via minimal clearance between the floating ring and laterally disposed flat surfaces formed within a modified gerotor pocket. The laterally disposed flat surfaces are formed in a precision manner in order to effect the required minimal lateral clearance.

In a second alternate preferred embodiment of the present invention, first and second lateral housing mounted positioning means are positioned within the gerotor pocket along the preferred eccentricity axis. Then the floating ring is positioned laterally with respect to the preferred eccentricity axis via the first and second lateral housing mounted positioning means engaging slots formed in opposite sides of the periphery of the floating ring.

In a third alternate preferred embodiment of the present invention, the floating ring is located laterally by a single pin fixedly mounted in the housing and engaging a hole formed in the floating ring in a laterally protruding portion thereof. Transverse loading causes the floating ring to bear against the pin and thence the housing. In a modified version of the third alternate preferred embodiment of the present invention, the pin is replaced by an adjustable eccentric pin whereby the lateral position of the floating ring can be adjusted in a manner similar to that described above with reference to the preferred embodiment.

Thus, a second improved method of supporting a gerotor set comprised in a gerotor pump has been enabled by the first, second and third alternate preferred embodiments of the present invention. This method comprises the steps of locating the outer rotor of a gerotor set within a floating ring, locating the floating ring laterally with reference to a preferred eccentricity axis of a gerotor pump, and allowing the outer rotor located within the floating ring to find its own eccentricity offset rotation axis location via the mesh of the gerotor set itself.

It is believed herein that Geroler technology similar in nature to that utilized in Char-Lynn Orbit Geroler motors manufactured by the Eaton Corporation (e.g., wherein rolls are incorporated in the outer rotor in place of the fixedly formed inwardly extending circularly shaped elements) has never been utilized in a standard gerotor pump wherein the outer rotor is rotationally driven by the inner rotor. However, such Geroler technology would generally be of benefit in gerotor pumps. Therefore, in a fourth alternate preferred embodiment of the present invention, another improved gerotor pump is provided wherein the inwardly extending circularly shaped elements are rolls specifically incorporated into the outer rotor thereof in place of more normally encountered inwardly extending circularly shaped lobes.

In a fifth alternate preferred embodiment of the present invention, modifications in porting are presented whereby relatively viscous fluid and/or high operational speeds can be used and/or obtained without bulk cavitation occurring in pumping chambers of gerotor pumps. In general, the modified porting comprises utilization of radial passages formed in outer rotors whereby fluid directly flows between individual pumping chambers and appropriate ones of inlet and outlet fluid commutation ports.

In a further teaching of the fifth alternate preferred embodiment, fluid commutation ports formed in a floating ring interdict the radial passages of the outer rotor. Fluid enters and leaves the fluid commutation ports via either side of the gerotor pocket and housing ports juxtaposed thereto. Sealing between sides is accomplished via pins freely moving within orthogonally positioned slots that act similarly to bi-directional check valves.

Thus, an improved method for conveying fluid into and out of pumping chambers of a gerotor pump has been enabled by the fifth alternate preferred embodiment of the present invention. This method comprises the steps of implementing radial passages in the outer rotor of a gerotor set, implementing fluid commutation ports interdicting only the radial passages, and utilizing movement of the radial passages over the ends of the fluid commutation ports for switching pumping chamber fluid connection from one fluid commutation port to the other.

It is important to maintain proper axial operating clearance in any of the improved gerotor pumps. If the clearance is too large, excessive leakage will occur thus reducing volumetric efficiency at higher pressures. If the clearance is too small, slight differential thermal expansion between the depth of the gerotor pocket and the thickness of the gerotor set could result in seizure at extreme temperature values. For instance, the housing might be fabricated of aluminum and the gerotor set fabricated of steel. In this case, differential thermal expansion could easily reduce axial clearance to zero and cause seizure at startup under very cold conditions.

This problem is obviated in a sixth alternate preferred embodiment of the present invention, wherein a pressure balancing plate is inserted in a pocket or pockets formed in either or both of the housing and/or cover plate, or alternately within the gerotor pocket itself. Pressure balancing plates are formed with at least the same plan view size as the outer rotor, and thus serve as one or both sides of the gerotor cavity. Each pressure balancing plate is located with reference to the preferred eccentricity axis and the preferred eccentricity offset rotation axis by registration of aligning pins in blind holes formed in the pressure balancing plate.

As the pressure balancing plates are urged toward the gerotor set, they serve generally the same purpose of limiting face leakage as pressure balancing bearing blocks do in many gear pumps. However, the disc brake like tendency of such pressure balancing bearing blocks to drag on the surfaces of the gears in such a gear pump may be obviated in any gerotor pump comprising a floating ring by forming its pressure balancing plate or plates large enough to bear axially upon the floating ring and then selectively forming the floating ring slightly thicker than the gerotor set. Then the axial force provided initially by compression of the sealing rings plus balancing forces provided by the sum of the products of pressure applied to each effective pressure balancing zone and the respective areas thereof maintains contact between the pressure balancing plate or plates and the floating ring, and the gerotor set operates without drag at the selected value of axial clearance.

Features described above in the first through sixth alternate preferred embodiments may be used singly or in combination to configure gerotor pumps having minimal part count and optimum manufacturing economy. In the case of a very high pressure gerotor pump however, it may be desirable to additionally eliminate the imposition of transverse loading on the drive shaft and yet generally maintain the self aligning capability described above.

Therefore, in a seventh alternate preferred embodiment of the present invention, universal gerotor pumps having independent pumping cartridges are provided wherein each of the independent pumping cartridges comprises a gerotor set, floating ring, and two pressure balancing plates. Transverse loading is internally supported within the independent pumping cartridges. The inner rotors are supported via inner rotor supporting axles that are alternately supported by hydrodynamic bearings operatively formed between the axles and bores of the pressure balancing plates, or by sleeve or needle bearings mounted in the pressure balancing plates. In the universal gerotor pumps, the outer rotor and the floating ring are able to float with reference to the inner rotor as previously taught. In addition, the pumping cartridges are able to float with reference to the drive shaft.

In order for any of the above described gerotor pumps to realize higher pressure output values it is of course imperative that the above noted commonly attained diametral lobe-to-lobe and lobe-to-groove clearances of perhaps 0.003 inch be significantly reduced. This is achieved in methods for re-contouring lobe tip regions of inner and/or outer rotors of gerotor sets according to any of the eighth, ninth and tenth alternate preferred embodiments of the present invention as presented below. In general, these methods entail initially forming only the tip regions of either or both of the outwardly extending lobes of the inner rotor and/or the inwardly extending lobes of the outer rotor in a slightly enlarged manner and then re-forming the tip regions as desired. In practice the tip regions are so formed during the powdered metal r manufacturing process mentioned above such that a line-to-line contact, or even an actual interference, would occur along the eccentricity axis if the inner and outer rotors were forced together.

In the method of the eighth alternate preferred embodiment of the present invention, the outer rotors are forcibly distorted by lateral compressive force (e.g., with respect to the eccentricity axes) just sufficiently for the provision of assembly clearance along the eccentricity axes for the inner rotors. This still allows for assembly of the inner rotors because the inner and outer rotors have been formed such that there is still some clearance along the lateral axis to initially form the gerotor sets. Then inward radial forces are applied to the outer rotors proximate to the lobe-to-groove contact points thus defining orthogonal orientation for the eccentricity axes. Next the gerotor sets are immersed in or by a fine lapping slurry. Then as the lateral compressive force is progressively relaxed during a sequential lapping operation, compressive force along the eccentricity axis is imposed upon the tip regions of the lobes as a function of remaining stress present in the outer rotors.

Lapping of the assembled gerotor sets is accomplished by rotationally driving them as they would be driven in a gerotor pump as the lateral compressive force is relaxed. Lapping occurs on tip regions of the N+1 inwardly extending lobes of the outer rotor and the N outwardly extending lobes of the inner rotor until both the lateral compressive force and remaining stress in the outer rotor are relaxed and working clearance values related to the size of the particles in the fine lapping slurry are obtained. Finally, the re-contoured gerotor sets are removed from the fine lapping slurry and cleaned.

In the ninth alternate preferred embodiment of the present invention, a method for “zone” size re-contouring tip regions of lobes of inner rotors for matching outer rotors formed in a standard manner is presented. This method involves lapping of only the tip regions of the outwardly extending lobes of the inner rotors whereby only they are initially formed in a slightly enlarged manner as described above. In this case, inner rotors are positioned within enlarged lapping tools that just clear the outwardly extending lobes of the inner rotors but are otherwise shaped like an outer rotor to form first lapping gerotor sets. Then inward radial forces are applied to the enlarged lapping tools to forcibly form lobe-to-groove contact points and thus determine orientation of eccentricity axes for the first lapping gerotor sets. Next the first lapping gerotor sets are immersed in or by a fine lapping slurry and rotated in order to lap the inner rotors in the manner described above until the desired inner rotor geometries are obtained.

In this case, the desired inner rotor geometries must be determined by accurate gaging methods. For instance, the radial location of the tip apexes of the inwardly extending lobes of outer rotors could be determined via utilization of plug go/no go gages whereby they could be separated into “zone” size determined batches and then the inner rotors lapped as described above until they are re-contoured into matching “zone” size determined batches as determined by ring go/no go gages.

In the tenth alternate preferred embodiment of the present invention, a method for re-contouring tip regions of inner and outer rotors in conformity with respective standardized first and second preferred sizes is presented wherein the tip regions of the outwardly extending lobes of inner rotors are lapped to the first preferred size, and the tip regions of the inwardly extending lobes of outer rotors are lapped to the second and mating preferred size. In this case, tip regions of the outwardly extending lobes of the inner rotors are lapped in exactly the same manner as described above in the ninth alternate preferred embodiment until the first preferred size is obtained. Additionally however, outer rotors are positioned around contracted lapping tools that just clear the inwardly extending lobes of the outer rotors but are otherwise shaped like an inner rotor to form second lapping gerotor sets. Then inward radial forces are applied to the outer rotors to forcibly form lobe-to-groove contact points and thus determine orientation of eccentricity axes for the second lapping sets. Next the second lapping gerotor sets are immersed in or by a lapping slurry and rotated in order to lap the outer rotors in the manner described above until the desired outer rotor geometries are obtained.

Thus, improved gerotor pumps configured according to the teachings of the preferred and alternate preferred embodiments of the present invention achieve the desired goals of achieving high pressure values and smooth performance as well as having reduced complexity and therefore reduced implementation cost relative to their performance capabilities. Preferably included are re-contoured lobe tips of comprised gerotor sets according to the teachings of the eighth, ninth or tenth alternate preferred embodiments in order to achieve the desired goal of re-contouring tip portions of lobes of gerotor sets in order to economically achieve the preferred diametral clearance values of 0.0005 to 0.001 inch between the critical lobe-to-lobe and lobe-to-groove contact points.

In a first group of aspects, then, the present invention is directed to improved gerotor pumps wherein the outer rotor is laterally constrained but allowed to float in an orthogonal direction whereby the actual eccentricity offset rotation axis location is determined by mesh of the gerotor set itself. Included are gerotor pumps wherein the N+1 inwardly extending circularly shaped elements are N+1 inwardly extending rolls. Also included are gerotor pumps wherein means are provided whereby the operative lateral position of the outer rotor can be adjusted.

In another aspect, the present invention is directed to a first improved method for supporting a gerotor set comprised in a gerotor pump, wherein the method comprises the steps of locating the outer rotor of a gerotor set laterally with reference to a preferred eccentricity axis of the gerotor pump, and allowing the outer rotor to find its own eccentricity offset rotation axis location via mesh of the gerotor set itself.

In other aspects the present invention is directed to improved gerotor pumps wherein the outer rotor is located within a floating ring and the floating ring is laterally constrained but allowed to float in the orthogonal direction whereby the actual eccentricity offset rotation axis location is determined by mesh of the gerotor set itself.

In another aspect, the present invention is directed to a second improved method for supporting a gerotor set comprised in a gerotor pump, wherein the method comprises the steps of locating the outer rotor of a gerotor set within a floating ring, locating the floating ring laterally with reference to a preferred eccentricity axis of the gerotor pump, and allowing the outer rotor located within the floating ring to find its own eccentricity offset rotation axis location via mesh of the gerotor set itself.

In still other aspects the present invention is directed to improved gerotor pumps wherein radial passages are formed connecting each groove located between the inwardly extending circularly shaped lobes and the outside circular surface of the outer rotor. Included are aspects wherein fluid commutation ports formed in the floating ring are utilized in place of the axially oriented fluid commutation ports.

In another aspect the present invention is directed to an improved method for conveying fluid into and out of pumping chambers of a gerotor pump, wherein the method comprises the steps of implementing radial passages in the outer rotor of a gerotor set, implementing fluid commutation ports interdicting only the radial passages, and utilizing movement of the radial passages over the ends of the fluid commutation ports for switching pumping chamber fluid connection from one fluid commutation port to the other.

In other aspects the present invention is directed to the improved gerotor pumps wherein at least one pressure balancing plate large enough to substantially cover the outer rotor is urged toward the gerotor set in the axial direction thereby limiting face leakage. Included are aspects wherein a floating ring is formed selectively thicker than the gerotor set, and further wherein at least one pressure balancing plate large enough to substantially cover the floating ring is urged into axial contact with the floating ring thereby permitting the gerotor set to operate without any drag at a selected value of axial clearance.

In still other aspects the present invention is directed to universal gerotor pumps wherein gerotor set are located within a floating ring and between pressure balancing plates wherein the gerotor set, floating ring, pressure balancing plates and an axle are combined in an independent pumping cartridge and further wherein the axle is supported for rotation within the pressure balancing plates and in turn supports the inner rotor, and further wherein the entire pumping cartridge is angularly oriented but allowed to otherwise float with reference to the drive shaft.

In another aspect, the present invention is directed to a third improved method for supporting a gerotor set comprised in a gerotor pump, wherein the method comprises the steps of locating the inner rotor of a gerotor set between first and second pressure balancing plates, locating the outer rotor of the gerotor set within a floating ring, locating the floating ring between the first and second pressure balancing plates and laterally with reference to the inner rotor whereby an independent pumping cartridge is formed, providing a rotational constraint for the independent pumping cartridge, allowing the outer rotor to find its own eccentricity offset rotation axis location with reference to the axis of rotation of the inner rotor via mesh of the gerotor set itself, and allowing the independent pumping cartridge as a whole to find its own operational position within its rotational constraint via rotational driving engagement of the inner rotor with the drive shaft.

In a final group of aspects, the present invention is directed to methods for forming conjugately-generated tip regions of inner and outer rotors, zone fitted tip regions of inner and outer rotors, or absolute sized generated tip regions of inner and outer rotors, wherein the methods in general comprise the steps of: initially forming either or both of tip regions of outwardly extending lobes of the inner rotors and inwardly extending lobes of the outer rotors in a slightly enlarged manner; assembling gerotor sets whose inner and outer rotor tip regions are to be conjugately-generated by compressively distorting the outer rotors, or assembling inner or outer rotors whose tip regions are to re-generated to a selected size on or within lapping tools formed similarly to outer or inner rotors, respectively; and then lapping the tip regions as required to form closely fitting gerotor sets in order to enable gerotor pumps to achieve higher pressure values.

### BRIEF DESCRIPTION OF THE DRAWING

A better understanding of the present invention will now be had with reference to the accompanying drawing, wherein like reference characters refer to like parts throughout the several views herein, and in which:

FIGS. 1A and 1B are sectional views of an improved gerotor pump according to a preferred embodiment of the present invention;

FIG. 2 is an exploded isometric view of operative elements of the improved gerotor pump according to the preferred embodiment of the present invention;

FIGS. 3A and 3B are respective ideally centered and offset plan view depictions of relative locations of operative elements of the improved gerotor pump according to the preferred embodiment of the present invention;

FIGS. 4A and 4B are graphical depictions of pressure ripple attained by the improved gerotor pump with its operative components ideally centered;

FIGS. 5A and 5B are graphical depictions of pressure ripple attained by the improved gerotor pump with its operative components slightly offset;

FIG. 6 is a sectional view of an eccentric cam follower alternately utilized in the improved gerotor pump also according to the preferred embodiment of the present invention;

FIG. 7 is an exploded isometric view of operative elements of a modified improved gerotor pump also according to the preferred embodiment of the present invention;

FIG. 8 is a flow chart depicting a first improved method for supporting the outer rotor of a gerotor set comprised in a gerotor pump;

FIGS. 9A and 9B are sectional views of another improved gerotor pump according to a first alternate preferred embodiment of the present invention;

FIG. 10 is an exploded isometric view of operative elements of the improved gerotor pump according to the first alternate preferred embodiment of the present invention;

FIGS. 11A and 11B are isometric views of alternate outer rotor elements also according to the first alternate preferred embodiment of the present invention;

FIG. 12 is an exploded isometric view of operative elements of another version of the improved gerotor pump according to a second alternate preferred embodiment of the present invention;

FIG. 13 is an exploded isometric view of operative elements of another version of the improved gerotor pump according to a third alternate preferred embodiment of the present invention;

FIG. 14 is an isometric view of an eccentric pin alternately utilized in the improved gerotor pump also according to the third alternate preferred embodiment of the present invention;

FIG. 15 is a flow chart depicting a second improved method for supporting the outer rotor of a gerotor set comprised in a gerotor pump;

FIG. 16 is an exploded isometric view of operative elements of another version of the improved gerotor pump according to a fourth alternate preferred embodiment of the present invention;

FIGS. 17A and 17B are plan views of alternate porting configurations for gerotor pumps according to a fifth alternate preferred embodiment of the present invention;

FIG. 18 is an exploded isometric view of operative elements of another version of the improved gerotor pump also according to the fifth alternate preferred embodiment of the present invention;

FIGS. 19A and 19B are plan views depicting a check valve utilized in the improved gerotor pump shown in FIG. 18;

FIG. 20 is a flow chart depicting an improved method for conveying fluid into and out of pumping chambers of a gerotor pump;

FIGS. 21A and 21B are isometric views of outer rotors alternately utilized in gerotor sets also according to the fifth alternate preferred embodiment of the present invention;

FIGS. 22A and 22B are exploded isometric views of operative elements of other versions of the improved gerotor pump according to a sixth alternate preferred embodiment of the present invention;

FIG. 23 is an exploded isometric view of operative elements of another version of the improved gerotor pump also according to the sixth alternate preferred embodiment of the present invention;

FIG. 24 is a sectional view of check valves utilized in the improved gerotor pump shown in FIG. 23;

FIG. 25 is a sectional view of an alternate gerotor set and floating ring assembly usable in the improved gerotor pump shown in FIG. 23;

FIGS. 26A and 26B are sectional views of an improved gerotor pump comprising various features presented in the first, second, fifth and sixth alternate preferred embodiments of the present invention;

FIG. 27 is an exploded isometric view of operative elements of a first independent pumping cartridge utilized in a first universal gerotor pump according to a seventh alternate preferred embodiment of the present invention;

FIG. 28 is an exploded isometric view of operative elements of the first universal gerotor pump;

FIG. 29 is an exploded isometric view of operative elements of a second independent pumping cartridge utilized in a second universal gerotor pump also according to the seventh alternate preferred embodiment of the present invention;

FIG. 30 is an exploded isometric view of operative elements of the second universal gerotor pump;

FIG. 31 is yet another flow chart depicting a third improved method for supporting the outer rotor of a gerotor set comprised in a gerotor pump;

FIGS. 32A and 32B are sectional views of a stand-alone improved gerotor pump comprising various features presented in the first, fifth, sixth and seventh alternate preferred embodiments of the present invention;

FIG. 33 is a plan view depicting an assembled prior art gerotor set;

FIGS. 34A and 34B are plan views respectively depicting inner and outer rotors of a gerotor set formed with enlarged lobe tip regions;

FIG. 35 is a plan view depicting the inner and outer rotors shown in FIGS. 34A and 34B assembled prior to lapping;

FIG. 36 is an isometric view of a dial automatic machine used for lapping the assembled inner and outer rotors shown in FIG. 35;

FIG. 37 is a plan view depicting a finish lapped contact point and the area immediately theresurrounding of the inner and outer rotors shown in FIG. 35;

FIG. 38 is a flow chart depicting a method for forming conjugately-generated tip regions of inner and outer rotors utilized in gerotor sets;

FIG. 39 is a plan view of an inner rotor assembled within an enlarged lapping tool shaped like an outer rotor prior to lapping;

FIGS. 40A and 40B are plan views respectively depicting measurement of lobe tip locations of outer and inner rotors;

FIG. 41 is a flow chart depicting a method for “zone” size re-contouring tip regions of lobes of inner rotors for matching outer rotors formed in a standard manner;

FIG. 42 is a plan view of an outer rotor assembled around a contracted lapping tool shaped like an inner rotor prior to lapping; and

FIG. 43 is a flow chart depicting a method for re-contouring tip regions of inner and outer rotors in conformity with respective standardized first and second preferred sizes.

### DETAILED DESCRIPTION OF THE PREFERRED EMBODIMENTS

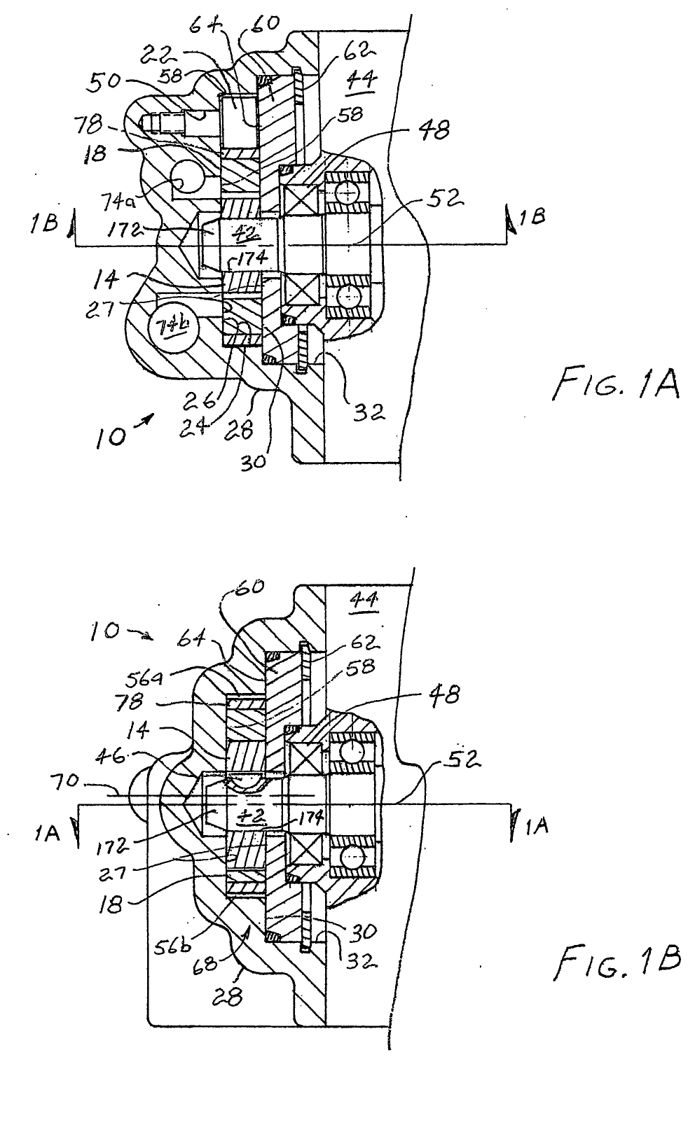

With reference now to FIGS. 1A, 1B 2, 3A and 3B, thereshown in sectional, exploded isometric and plan views is an improved gerotor pump 10 according to a preferred embodiment of the present invention in which a gerotor set 12 comprising an inner rotor 14 having N nominally circularly shaped outwardly extending lobes 16 and an eccentrically disposed outer rotor 18 having N+1 inwardly extending circularly shaped elements 20 is located between a cam follower 22 and a flat surface 24 formed as part of a gerotor pocket 26 formed in turn within a housing 28. The gerotor pocket 26 is formed in a portion of the housing 28 extending beyond a shoulder 30 that terminates a bore 32 also formed therein. The inwardly extending circularly shaped elements 20 are depicted as being inwardly extending circularly shaped lobes 34 in FIG. 2. However, the inwardly extending circularly shaped elements 20 could also be rolls 182 as fully described below in conjunction with a fourth alternate preferred embodiment of the present invention and depicted in FIG. 16.

N+1 pumping chambers 36 are formed between N nominal line seals 38 provided by the mesh of the outwardly and inwardly extending lobes and circularly shaped elements 16 and 20 and an additional nominal line seal 38 between one inwardly extending circularly shaped element 20 and a juxtaposed one of N grooves 40 of the inner rotor 14 nearest the “in-mesh” position. The inner rotor 14 is directly driven by the output shaft 42 of a drive motor 44 (hereinafter “the drive shaft 42”) via a feature enabling transmission of torque from one element to another such as implemented herein by Woodruff key 46.

The outer rotor 18 is rotationally driven in turn by the inner rotor 14 via mesh of the outwardly extending lobes 16 with the inwardly extending circularly shaped elements 20 via those line seals 38 instantly positioned whereat they can transmit a tangential driving force component.

In any of gerotor pumps 10, or 100, 130, 150, 180, 230, 260 and 270 yet to be described, blind insertion of the drive shaft 42 is a factor in volume production. Such blind insertion is complicated by the necessity of providing interfacing means for transmitting torque between the drive shaft 42 and inner rotor 14. Because of the concomitant necessity for supporting transverse loading, it is preferable to implement the drive shaft 42 as a round shaft with a single feature such as Woodruff key 46. Insertion of the drive shaft 42 is assisted by locating shaft seal 48 within the motor 44; configuring the drive shaft 42 with a conical shape as shown at numerical indicator 172; laterally constraining the Woodruff key 46 with temporary constraining means (not shown); and then slowly rotating the drive shaft 42 within bore 174 of the inner rotor 14 until the Woodruff key 46 engages key slot 176.

The gerotor pump 10 is intended for unidirectional use with reference to differential pressure thereacross. Thus, the cam follower 22 is located on the higher pressure side of the gerotor pump 10 in a standard manner by a bore 50 formed in the gerotor pocket 26. The bore 50 is precisely located a distance equal to the sum of the outside radius of the outer rotor 18 and the outside radius of the cam follower 22 from axis of rotation 52 of the drive shaft 42. This is done in order to locate the outer rotor 18 along a preferred eccentricity axis 54 as accurately as possible.

The gerotor pocket 26 is contoured to provide at least nominal clearance for the outer rotor 18 and the cam follower 22, and specifically so as to provide freedom of motion in the orthogonal direction for the gerotor set 12 as indicated by numerical indicators 56a and 56b. The bore 50 is actually formed in an inner surface 58 of the gerotor pocket 26, and the inner surface 58 is formed at a slightly greater depth from the shoulder 30 than the axial thickness of the gerotor set 12 whereby the inner surface 58 serves as a first side of a gerotor cavity 27. A cover plate 60 is inserted into the bore 32 against the shoulder 30 and is forcibly retained thereat by a beveled retaining ring 62 whereby its inner surface 64 serves as the second side of the gerotor cavity 27. Proper indexing for the cover plate 60 is provided via engagement of alignment pins 66 with blind holes 68 formed in either of the shoulder 30 and the cover plate 60 (the holes 68 formed in the cover plate 60 are not located within a sectional view plane and thus numerical indicator 68 only indicates their presence).

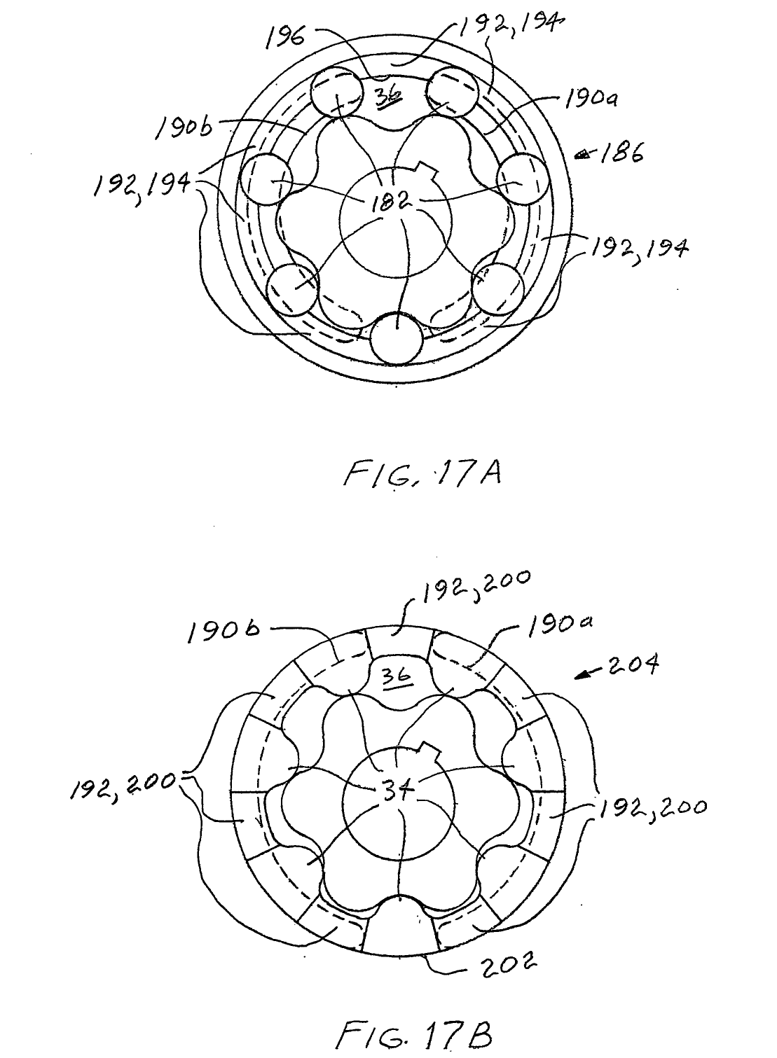

The gerotor set 12 is oriented with the outer rotor 18 nominally disposed about a preferred eccentricity offset rotation axis 70. It is shown in FIGS. 1B and 2, for instance, as being above the axis of rotation 52. Respective axially oriented fluid commutation ports 72a and 72b are formed in the inner surface 58 on either side of the preferred eccentricity axis 54 for selectively conveying fluid between the pumping chambers 36 and respective housing ports 74a and 74b. The axially oriented fluid commutation ports 72a and 72b can be formed according to dimensions provided by the gerotor set manufacturer. Such dimensions are tabulated for a wide range of gerotor sets in conjunction with FIG. 4 of a catalog entitled “Gerotor Selection and Pump Design” available from Nichols Portland (hereinafter “the Nichols Portland catalog”). Alternately they can be formed as curved slot shaped fluid commutation ports 190a and 190b used either in conjunction with rolls 182 inserted in modified outer rotor 184, or radial face slots 200 formed in modified outer rotor 202 as fully described below in accordance with a fifth alternate preferred embodiment of the present invention, and respectively depicted in FIGS. 17A and 17B. For convenience however, they will herein be otherwise generally referred to simply as the axially oriented fluid commutation ports 72a and 72b. In any case, the preferred eccentricity axis 54 is, of course, an imaginary line that intersects the axis of rotation 52 and the preferred eccentricity offset rotation axis 70.

As implied above, the outer rotor 18 is urged laterally outward by a force derived from fluid pressure present at the higher pressure one of the axially oriented fluid commutation ports 72a and 72b. In order to support the outer rotor 18 against that force, the cam follower 22 is located on that side of the outer rotor 18. If the gerotor pump 10 operates with clockwise rotation and is in fact being utilized as a pump, the higher pressure one of the fluid commutation ports 72a and 72b would of course be an outlet fluid commutation port 72a and that case is so depicted in FIG. 2. On the other hand, if the gerotor pump 10 operates with clockwise rotation and is being utilized as a hydraulic motor, the higher pressure would be present at the other or inlet fluid commutation port 72b and the cam follower 22 would be on the other side in the location indicated by numerical indictor 76.

In operation, the drive shaft 42 as well as other components of the gerotor pump 10 are subject to slight deflections in response to differential pressure induced transverse loading (hereinafter “transverse loading” or “the transverse loading”). The outer rotor 18 is concomitantly subjected to an equal and oppositely directed transverse loading with reference to that applied to the drive shaft 42 whereby it flexes sufficiently to be supported laterally by the cam follower 22. The cam follower 22 suffers internal deflection as well. In some cases it may be necessary to supplement the outer rotor 18 with a hardened steel tire 78 in order to properly support such transverse loading. As the differential pressure increases and causes further deflection of the components, the outer rotor 18 or steel tire 78 (if used) is free to roll on the cam follower 22 in order to allow the instant position of an actual eccentricity offset rotation axis 70′ to be determined by the mesh of the gerotor set 12 itself.

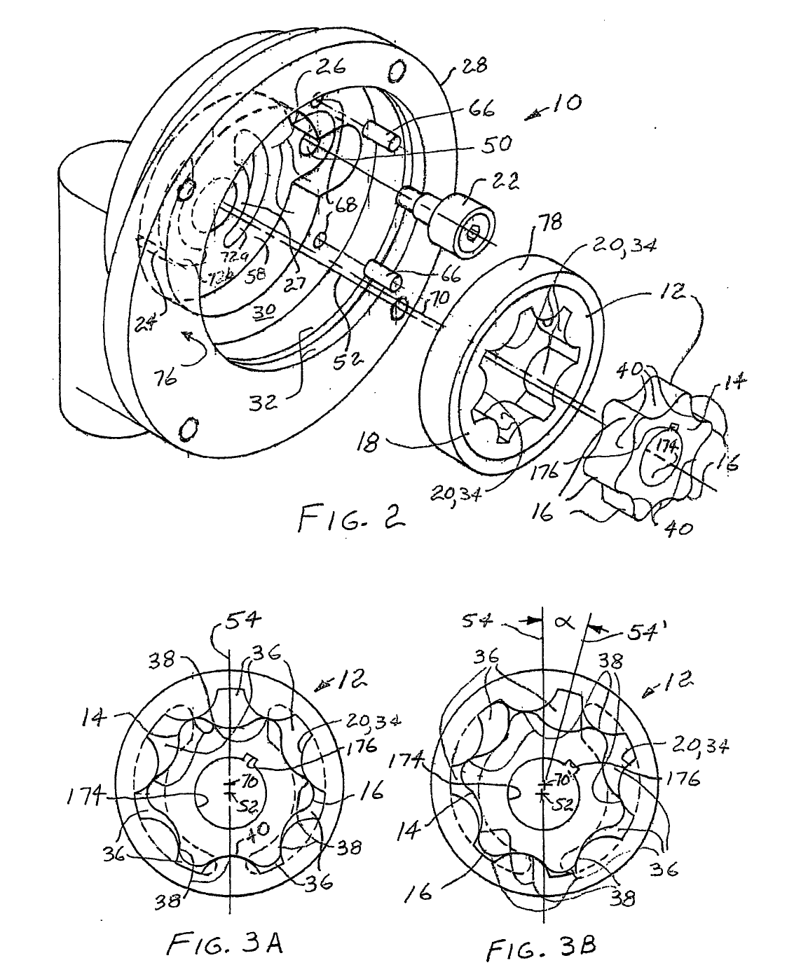

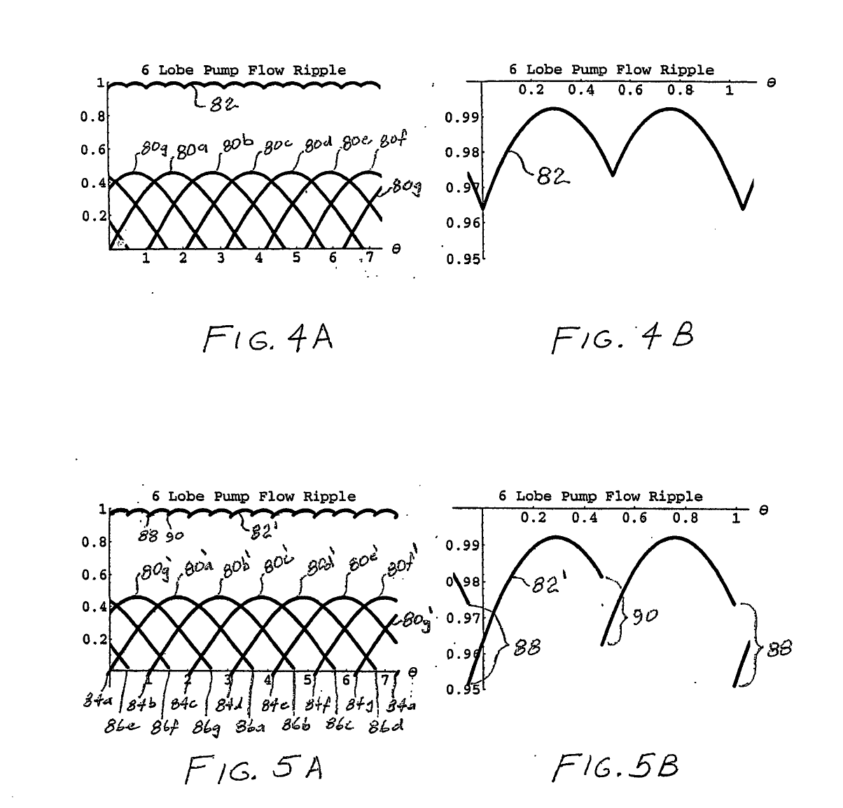

Relative displacements of the drive shaft 42 and gerotor set 12 resulting from such transverse loading are comparatively depicted between the plan views shown FIGS. 3A and 3B. FIG. 3A depicts these components in an ideally centered (e.g., presumably in a nominal unloaded) state and FIG. 3B, in an exaggerated manner, depicts the drive shaft 42, and therefore the axis of rotation 52 deflected to the left and the outer rotor 18 deflected slightly to the right in as they might be in a highly loaded state. In FIG. 3A, the components are positioned symmetrically with reference to the preferred eccentricity axis 54. However, they are asymmetrically positioned under load as shown in FIG. 3B thereby defining an actual relative position for the eccentricity offset rotation axis 70′ that results in an actual location for the eccentricity axis 54′ offset from the preferred eccentricity axis 54 by a port timing error angle a. As stated above, the angle a is depicted in an exaggerated manner. In reality, a more representative maximum value for the angle a is perhaps 3 degrees for small gerotor pumps 10 (e.g., with the outer rotor 18 having an outside diameter in the order of φ1 in.) and 2 degrees for large gerotor pumps 10 (e.g., with the outer rotor 18 having an outside diameter in the order of φ3 in.).

Even such small port timing error angles can have a significant effect on theoretical pump output pressure ripple as is comparatively depicted between FIGS. 4A and 4B, and FIGS. 5A and 5B. FIGS. 4A and 4B graphically represent fluid flow delivery from an ideally centered gerotor set 12 such as depicted in FIG. 3A while FIGS. 5A and 5B graphically represent the highly loaded case depicted in FIG. 3B with the angle a equal to 3 degrees. In FIG. 4A each of identical but phase shifted individual fluid flow delivery curves 80a through 80g represents fluid flow delivery from one of the N+1 pumping chambers 36. The curves 80a through 80g differ slightly from purely sinusoidal form in that some second and third harmonics are present. This is shown by the slightly asymmetric form of summation fluid flow delivery curve 82 representing the summed fluid flow delivery from the gerotor pump 10. The detailed nature of this asymmetry can be seen more clearly in FIG. 4B where an enlarged portion of the summation fluid flow delivery curve 82 is depicted.

On the other hand, in FIG. 5A each of respective initiating and terminating points 84a through 84g and 86a through 86g of similar fluid flow delivery curves 80a′ through 80g′ leads its zero crossing point by 3 degrees. This results in theoretical discontinuities 88 and 90 in the resulting summation fluid flow delivery curve 82′ as most clearly depicted in FIG. 5B. Although curve 82′ indicates an increase of about 45% in peak-to-peak ripple relative to the curve 82 shown in FIG. 4B, it is unlikely that the sharp discontinuities shown in curve 82′ would actually ever be realized. Still, such degradation in performance should be avoided if possible. One solution could be to form the housing in such a manner that the initial position of the drive shaft 42 is offset in the opposite direction by a selected amount so that the angle a has an approximately zero value whenever the gerotor pump 10 is delivering pressurized fluid at working pressure values.

As a practical matter, it is difficult to achieve the ideally centered condition shown in FIG. 3A. In practical applications the required tolerances are simply too small to repetitively realize the ideally centered condition. By way of illustration, the Nichols Portland catalog lists a gerotor type 6020 (i.e., meaning that N=6 and that the gerotor set has a displacement of 0.2 in.³/rev. per inch of length) with an eccentricity offset rotation axis location value of only 0.052 in. from the axis of rotation of the inner rotor. In this case, a relative deflection of 0.0027 in. of the drive shaft 42 vs. the outer rotor 18 will generate a value of α equal to 3 degrees. By way of reference, the Nichols Portland catalog outlines a typical “high pressure pump” of the present art (e.g., as described hereinabove) having an “O.D. clearance of 0.003 in. to 0.005 in.” and a tolerance on locating the eccentricity offset rotation axis of “±0.0008 in.”. Since the outer rotor of any standard gerotor pump would shift significantly within its “O.D. clearance” in establishing its supporting hydrodynamic bearing and a lateral shift of perhaps 0.0005 within the shaft bearing would be typical, and further, tolerances of perhaps ±0.003 in. might be typical in forming the ends of the axially oriented fluid commutation ports 72a and 72b, it seems likely that present art gerotor pumps may well have difficulty in actually achieving precision porting timing wherein effective eccentricity axis offset error values of less than 3 degrees are attained.

In passing it should be noted that a similar porting problem exists with piston pumps. Piston pumps have similar identical but phase shifted individual fluid flow delivery curves. Those curves usually have a purely sinusoidal form because the flow displacement is usually based upon a swash plate that generates a sinusoidal mechanical displacement of the pistons within their cylinders. However, the individual cylinders are ported in an exactly similar way to the axially oriented fluid commutation ports 72a and 72b described above and are thus subject to the same types of positional errors and flow discontinuities as described above.

In any case, the cam follower derived lateral constraint of the gerotor set 12 can beneficially be altered in an otherwise identical unidirectional gerotor pump 10 (not shown) via replacing the cam follower 22 with an adjustable eccentric cam follower 92 such as that shown in FIG. 6 whereby the operative lateral position of the outer rotor 18 can be adjusted. Thus, a so modified gerotor pump 10 can be mounted on the drive motor 44, run under desired output delivery conditions and then the adjustable eccentric cam follower 92 adjusted for smoothest running and minimum pump noise. An adjustment hexagonal socket 94 is provided in the adjustable eccentric cam follower 92 for rotational adjustment thereof by a hexagonal key. In addition, an O-ring seal 96 and a nut 98 are provided for respectively sealing the penetration of the housing 28 by the adjustable eccentric cam follower 92, and holding it in place.

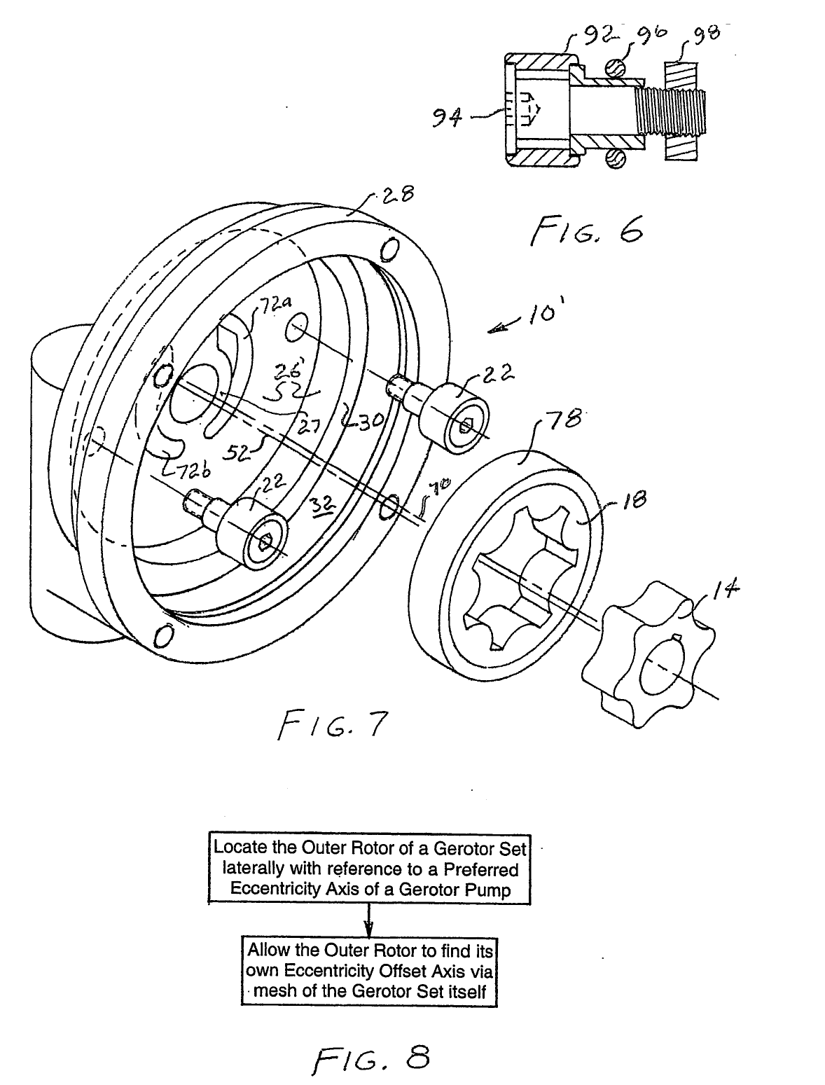

With reference now to FIG. 7, thereshown in an exploded isometric view is a modified gerotor pump 10′ also according to the preferred embodiment of the present invention in which an additional cam follower 22 is utilized in place of the flat surface 24 for supporting the outer rotor 18 in the opposite direction in the event of reversed pressure application. Thus, the gerotor pump 10′ can interchangeably be utilized as a bi-directional pump and/or as a bi-directional hydraulic motor.

Although gerotor pocket 26′ could have been formed with nominal clearance for the outer rotor 18 and cam followers 22 similarly to the gerotor pocket 26, it and bore 32 are depicted as being formed concentric with the axis of rotation 52. Thus, there is no requirement for the alignment pins 66 or holes in the shoulder 30 (or a cover plate 60′—not shown).

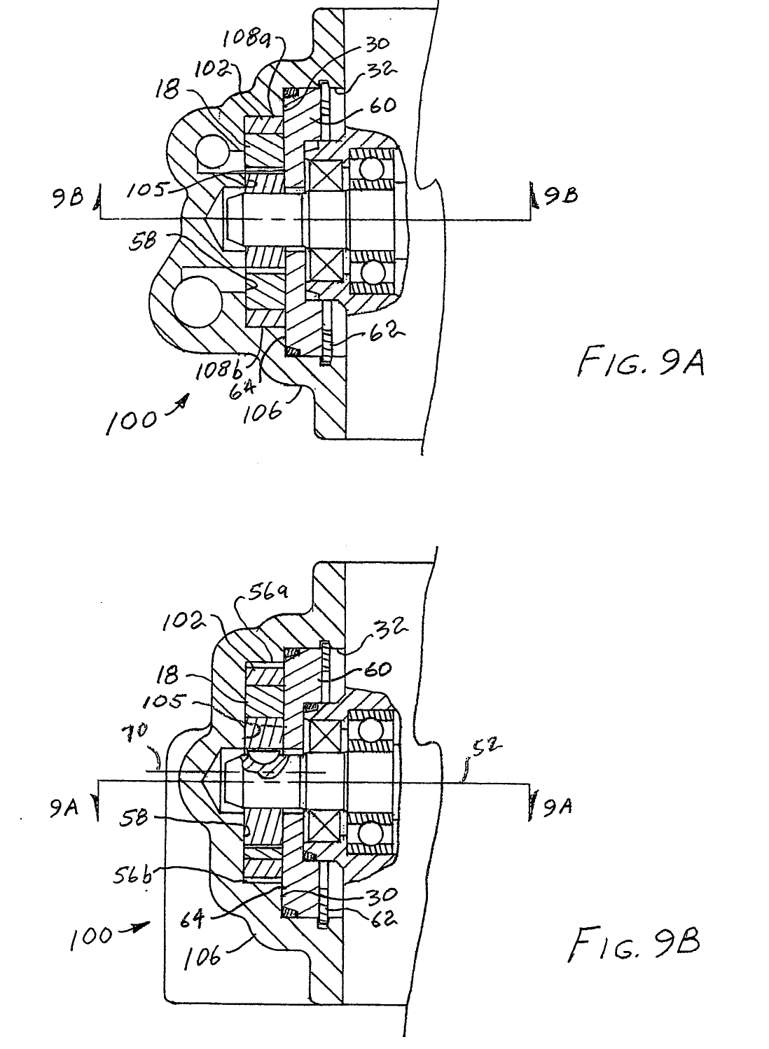

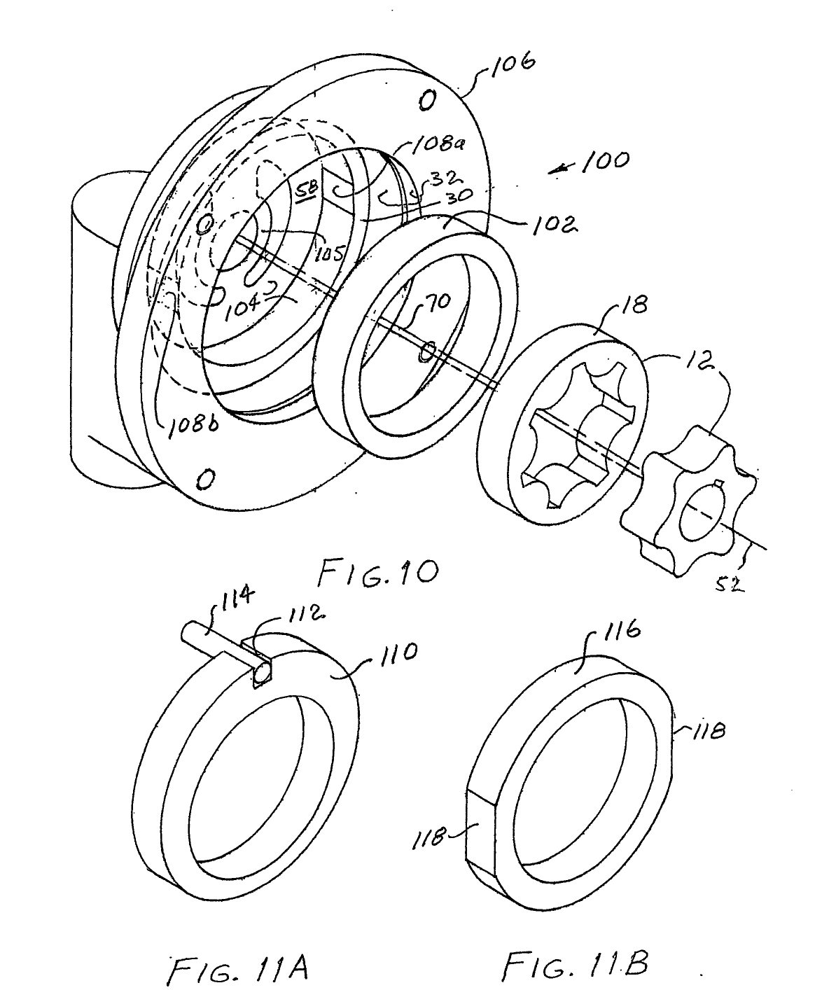

A first improved method of supporting a gerotor set comprised in a gerotor pump has been enabled by the preferred embodiment of the present invention. As depicted in FIG. 8, this method comprises the steps of locating the outer rotor of a gerotor set laterally with reference to a preferred eccentricity axis of the gerotor pump, and allowing the outer rotor to find its own eccentricity offset rotation axis location via mesh of the gerotor set itself.

As a practical matter, optimal use of the first improved method of supporting a gerotor set 12 comprised in a gerotor pump 10 is limited to applications wherein the gerotor set 12 operates at relatively low fluid pressures and/or low speeds. In part, this is because the cam follower 22 is generally much smaller than the steel tire 78 or the outer rotor 18 and must rotate at a significantly faster speed than the gerotor set 12. This is a problem because even cam followers comprising roll separators are subject to significant load de-rating. Further, cam followers having higher load values generally comprise a full complement of rolls and are themselves limited to relatively low speed operation.

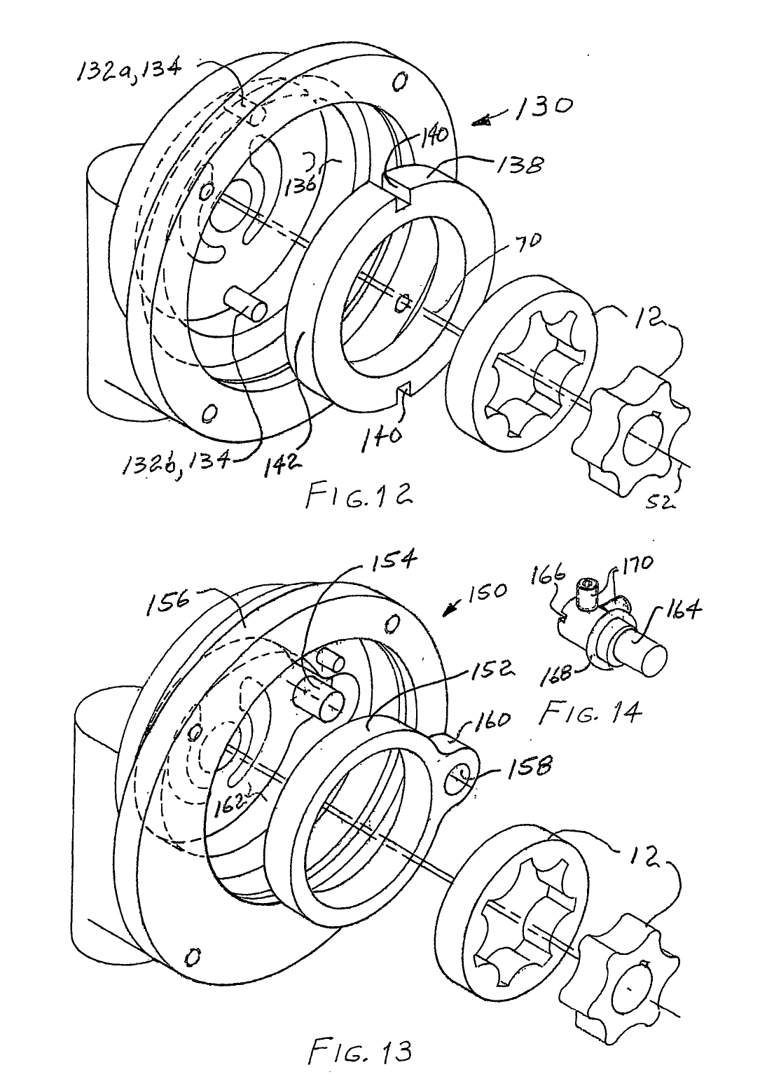

However, other methods of similarly constraining the gerotor set 12 can be used without departing from the spirit of the present invention in order to markedly increase operational speeds. For instance, shown in FIGS. 9A, 9B and 10 in sectional and exploded isometric views is another improved gerotor pump 100 according to a first alternate preferred embodiment of the present invention. In gerotor pump 100, the outer rotor 18 of a gerotor set 12 is supported for high speed rotation by a hydrodynamic bearing within a nominally stationary floating ring 102. The floating ring 102 and the gerotor set 12 are located within a modified gerotor pocket 104 formed in a modified housing 106. Laterally disposed flat surfaces 108a and 108b of the gerotor pocket 104 are symmetrically formed with reference to the preferred location of the eccentricity offset rotation axis 70 with minimal clearance for the floating ring 102. Freedom of motion for the floating ring 102 is provided at the top and bottom portions of the gerotor pocket 104 as again indicated by numerical indicators 56a and 56b.

As before, the inner surface 58 of the gerotor pocket 104 is formed at a minimally greater depth from the shoulder 30 than the axial thickness of the gerotor set 12 whereby the inner surface 58 serves as a first side of a gerotor cavity 105. Also as before, the cover plate 60 is inserted into the bore 32 against the shoulder 30 and is forcibly retained thereat by a beveled retaining ring 62 whereby its inner surface 64 serves as the second side of the gerotor cavity 105. Further, the cover plate 60 and bore 32 are again formed concentric with the axis of rotation 52 whereby no alignment pins 66 are required. As differential pressure increases and causes deflection of the components, the floating ring 102 is free to roll on the selected one of the flat surfaces 108a or 108b in order to allow the instant position of an actual eccentricity offset rotation axis 70′ to be determined by the mesh of the gerotor set 12 itself.

On the other hand, if floating ring rotation is deemed undesirable, an enlarged floating ring 110 having an eccentric bore with a single radially oriented slot 112 formed in the thickest portion of the ring can be used as shown in FIG. 11A. In this case, a single housing mounted pin 114 engages the slot 112 in order to preclude floating ring rotation. Alternately, a floating ring 116 having opposing flats 118 can be utilized as shown in FIG. 11B. In this case, the opposing flats 118 slidingly engage a pair of elongated laterally disposed flat surfaces 108a′ and 108b′ (not shown) in order to preclude floating ring rotation. This has the additional advantage of spreading the transverse loading derived forces over either of the laterally disposed flat surfaces 108a′ or 108b′ as opposed to a line contact of the floating ring 102 on laterally disposed flat surfaces 108a or 108b.

Still other methods of similarly constraining the gerotor set 12 can be used without departing from the spirit of the present invention. For instance, shown in FIG. 12 is another improved gerotor pump 130 according to a second alternate preferred embodiment of the present invention. In gerotor pump 130, first and second housing mounted lateral positioning means 132a and 132b, implemented herein by pins 134, are positioned in top and bottom portions of another modified gerotor pocket 136 thus defining a preferred location for the eccentricity offset rotation axis 70. Then a modified floating ring 138 is positioned about the preferred location of the eccentricity offset rotation axis 70 via the two pins 134 engaging slots 140 formed in opposite sides of the periphery 142 of the floating ring 138. Thus, minute motion of the floating ring 138 with respect to the fixed pins 134 provides the desired orthogonal freedom of motion. In this case the floating ring 138 is automatically precluded from rotation by engagement with the two pins 134.

Yet another method of similarly constraining the gerotor set 12 is depicted in FIG. 13. Shown in FIG. 13 is another improved gerotor pump 150 according to a third alternate preferred embodiment of the present invention. In gerotor pump 150, a differently modified floating ring 152 is located laterally via a single pin 154 fixedly mounted in a modified housing 156 and engaging a hole 158 formed in the floating ring 152 in a laterally protruding portion 160 thereof. A gerotor pocket 162 is again contoured to at least provide nominal clearance for the floating ring 152 including the laterally protruding portion 160. Freedom of motion in the orthogonal direction for the floating ring 152 is again provided by forming the gerotor pocket 162 in a slightly enlarged manner.

The floating ring 152 is again precluded from rotation. In this case however, this is accomplished via combination of the mesh of the gerotor set 12 and the engagement of the pin 154 in the hole 158.

This type of lateral constraint of the gerotor set 12 can enable adjustment of the lateral position of the floating ring 152 and the gerotor set 12 similarly to the above explained adjustment utilizing an adjustable eccentric cam follower 92. This is accomplished via replacing the pin 154 by an adjustable eccentric pin 164 such as depicted in FIG. 14 whereby the lateral position of the floating ring 152 can similarly be adjusted. In this case, an adjustment slot 166 is provided in the adjustable eccentric pin 164 for rotational adjustment thereof by a screwdriver. In addition, an O-ring seal 168 and clamping set screws 170 are provided for respectively sealing the penetration of the housing 156 by the adjustable eccentric pin 164, and holding it in place.

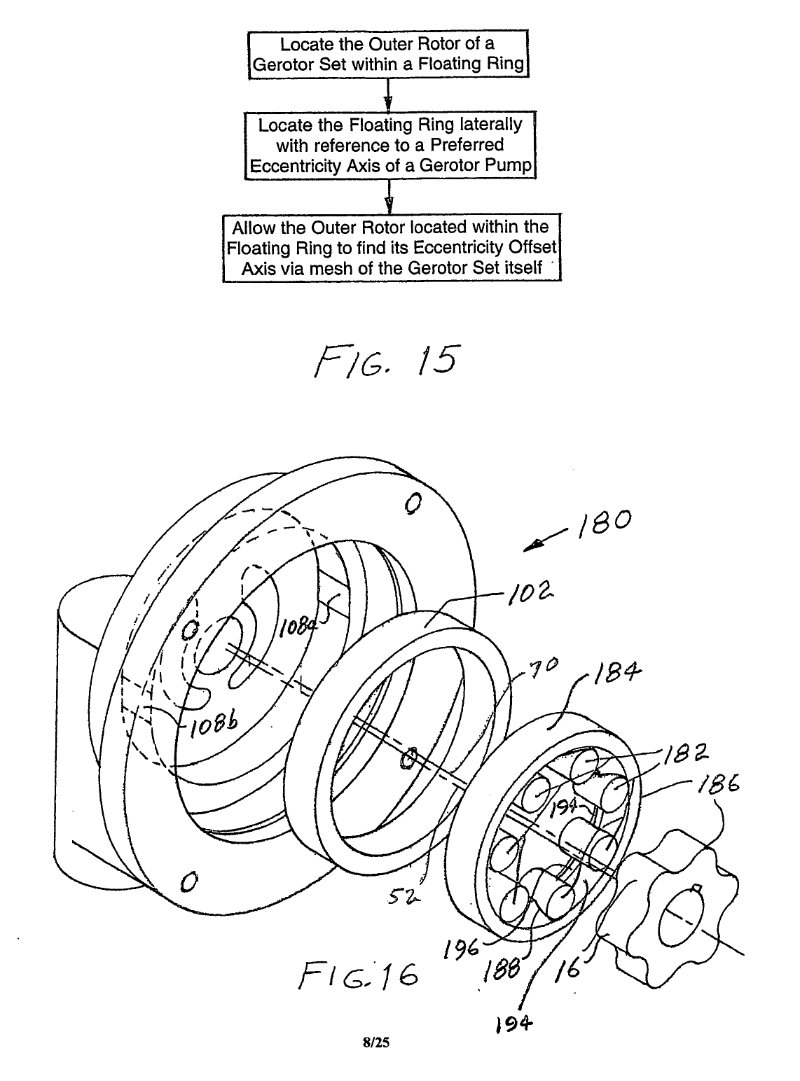

A second improved method of supporting gerotor sets comprised in gerotor pumps has been enabled by the first, second and third alternate preferred embodiments of the present invention. As depicted in FIG. 15, this method comprises the steps of locating the outer rotor of a gerotor set within a floating ring, locating the floating ring laterally with reference to a preferred eccentricity axis of the gerotor pump, and allowing the outer rotor located within the floating ring to find its own eccentricity offset rotation axis location via the mesh of the gerotor set itself.

With reference now to FIG. 16, thereshown in an exploded isometric view is an improved gerotor pump 180 according to a fourth alternate preferred embodiment of the present invention. FIG. 16 depicts the gerotor pump 180 as being derived from the gerotor pump 100. This is for convenience only, as any of the gerotor pumps 10, 130 or 150 could have been so utilized as well. In the gerotor pump 180 rolls 182 are incorporated in a modified outer rotor 184 of a modified gerotor set 186 in place of the more normally encountered fixedly formed inwardly extending circularly shaped lobes 34. The rolls 182 are formed with the same length as the thickness of the inner and outer rotors 14 and 184, and inserted in partial bores 188 formed in the outer rotor 184.

In operation, the rolls 182 accelerate from near zero relative rotational speed (e.g., with reference to the outer rotor 184) at the in-mesh position to a maximum relative rotational speed as each roll 182 moves over a juxtaposed outwardly extending lobe 16 and attains a significant relative motion component. Finally, each roll 182 decelerates back to the near zero relative rotational speed as it returns to the in-mesh position. In so doing, the rolls 182 form hydrodynamic bearings within the partial bores 188 thereby supporting forces transmitted by the line seals 38 without Coulomb friction and wear.

Generally, outwardly extending lobes 16 of the inner rotor 14 and inwardly extending circularly shaped elements 20 of the outer rotor 18 tend to largely block axially oriented fluid commutation ports 72a or 72b configured as recommended by Nichols Portland—especially near the “in-mesh” position. Therefore, in a fifth alternate preferred embodiment of the present invention, modifications in porting are presented whereby relatively viscous fluid and/or high operational speeds can be used and/or obtained without bulk cavitation occurring in gerotor pump pumping chambers. In general, the modified porting comprises utilization of radial passages 192 formed in outer rotors thereof such that each fluidly communicates with an individual pumping chamber 36 in conjunction with fluid commutation ports 190a and 190b formed for selective interdiction with the radial passages 192 so as to more effectively convey fluid from or to housing ports of such gerotor pumps. In a first type of the modified porting, the fluid commutation ports 190a and 190b are implemented as curved slot shaped fluid commutation ports of uniform radial size formed nominally concentric with the preferred eccentricity offset rotation axis 70. In a second type of the modified porting, radial porting is implemented wherein the radial passages 192 are implemented as radial face slots 200 that fluidly communicate via face fluid commutation ports 214 formed in a floating ring 212.

Depicted in FIG. 17A is an implementation of the first type of modified porting arrangement wherein a gerotor set 186 is utilized with the radial passages 192 being configured as spaces between the rolls 182. In order to provide adequate flow channels to fluidly connect the curved slot shaped fluid commutation ports 190a and 190b to the pumping chambers 36, chamfers 194 are formed between either side of the outer rotor 184 and its through bore 196 as can more clearly be seen in either of FIGS. 16 or 21B. The curved slot shaped fluid commutation ports 190a and 190b are formed symmetrically with respect to the path of the rolls 182 whereby the curved slot shaped fluid commutation ports 190a and 190b interdict only with the rolls 182. The spacing between ends of the curved slot shaped fluid commutation ports 190a and 190b is equal to the spacing between rolls 182. Switching of any pumping chamber 36 occurs when its trailing roll 182 covers the end of either of the curved slot shaped fluid commutation ports 190a or 190b and its leading roll 182 begins to uncover the other.

Depicted in FIG. 17B is another implementation of the first type of modified porting arrangement wherein the curved slot shaped fluid commutation ports 190a and 190b are utilized in conjunction with inwardly extending circularly shaped lobes 34. In this case, the radial face slots 200 are formed between the inwardly extending circularly shaped lobes 34. The radial face slots 200 are formed on both sides of a so modified outer rotor 202 comprised within a gerotor set 204. And of course, the gerotor set 204 must be utilized with one of floating rings 102, 110, 116, 138 and 152 described above, or 212, 274, 300, 346 and 374 yet to be described in order to seal the radial face slots 200 from general fluid communication from either side of a respective gerotor pocket to the other. In this case, the curved slot shaped fluid commutation ports 190a and 190b are formed in a concentric manner with respect to the outer rotor 202, and further are formed such that they interdict only with the radial face slots 200 in a manner similar to that explained above with reference to the rolls 182. The spacing between the ends of the curved slot shaped fluid commutation ports 190a and 190b is equal to the width of the radial face slots 200.

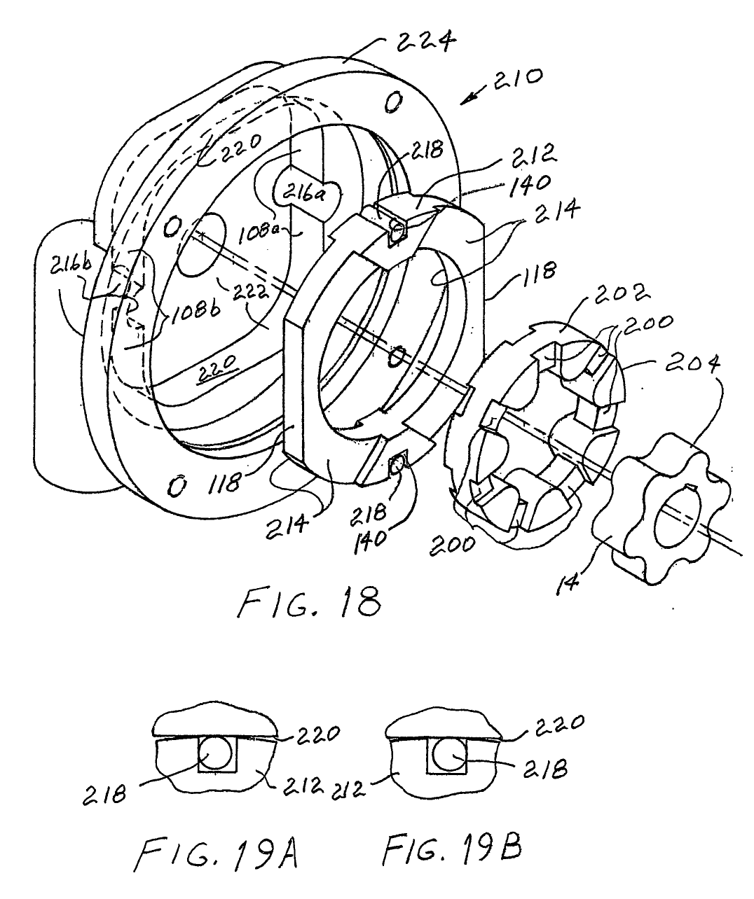

With reference now to FIG. 18, thereshown in an exploded isometric view is an improved gerotor pump 210 also according to the fifth alternate preferred embodiment of the present invention wherein the second type of modified porting arrangement is implemented. In this case, a floating ring 212 comprising opposing flats 118 as described above in the first alternate preferred embodiment additionally comprises face fluid commutation ports 214 formed in either side. The face fluid commutation ports 214 interdict radial face slots 200 formed on either side of an outer rotor 202 in a radial manner. Fluid enters and leaves the face fluid commutation ports 214 via axial portions of housing ports 216a and 216b penetrating nominal centers of the flat surfaces 108a and 108b and therefore juxtaposed to the opposing flats 118.

Orthogonal sealing between one side of the preferred eccentricity axis 54 and the other is accomplished via pins 218 freely moving within orthogonally positioned slots 140 formed similarly to those described above in the second alternate preferred embodiment. As shown in FIGS. 19A and 19B, the pins 218 act as bi-directional check valves in sealing the nominal clearance space between orthogonal extremities of the floating ring 212 and juxtaposed surfaces 220 of gerotor cavity 222 formed in housing 224. As depicted in FIG. 19A, pin 218 is oriented in a manner precluding passage of pressurized fluid from right to left while as depicted in FIG. 19B, the pin 218 is oriented in a manner precluding passage of pressurized fluid from left to right. Again, spacing between ends of the face fluid commutation ports 214 is equal to the width of the radial face slots 200.

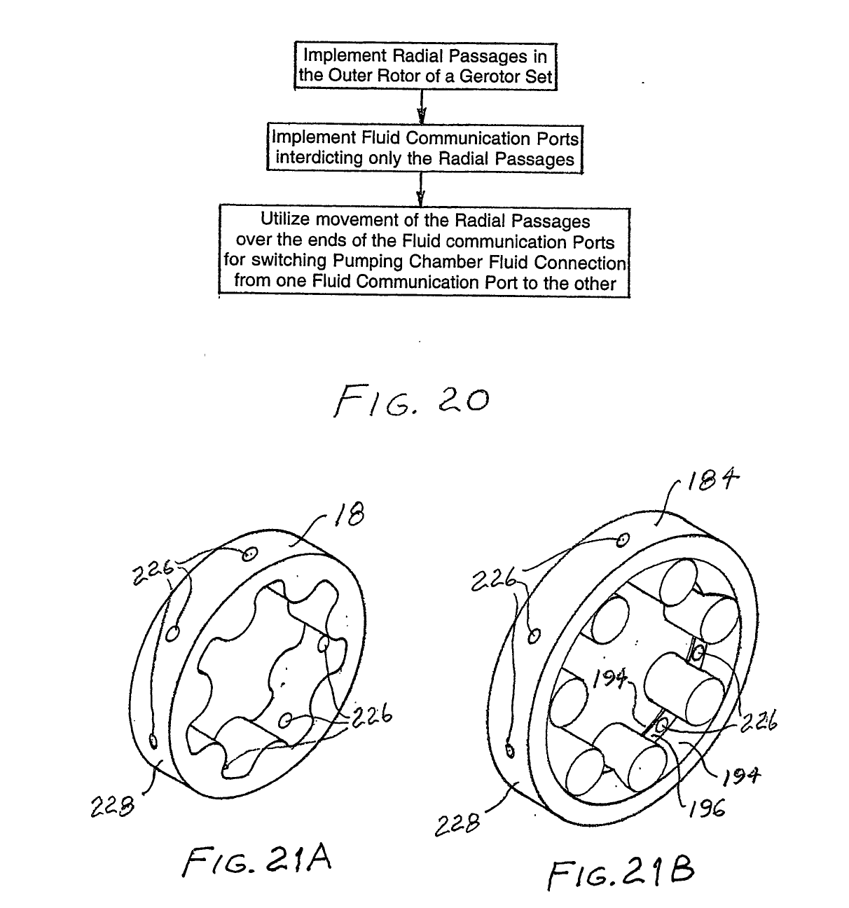

In improved gerotor pumps comprising either type of modified porting arrangement, improved performance with viscous fluids and/or at high operational speeds is obtained because the rate at which either of fluid commutation ports 190 or 214 is opened or closed is significantly quicker than with axially oriented fluid commutation ports 72a or 72b configured as recommended by Nichols Portland. Thus, an improved method for conveying fluid into and out of pumping chambers of a gerotor pump has been enabled as is depicted in FIG. 20. This method comprises the steps of implementing radial passages in the outer rotor of a gerotor set, implementing fluid commutation ports interdicting only the radial passages, and utilizing movement of the radial passages over the ends of the fluid commutation ports for switching pumping chamber fluid connection from one fluid commutation port to the other.

In passing however, it should be noted that improved gerotor pumps comprising any version of the modified porting arrangement described above involve radial fluid flow components subject to centrifugal force. This is especially true in the cases of improved gerotor pump 210 already described, and improved gerotor pumps 270, 310, 370 and 400 to be described below. By way of example, if the improved gerotor pump 210 were to be implemented using the afore mentioned standard Nichols Portland model 6170 gerotor set, then differential pressures approaching 5 PSI could be expected at an input rotational speed of about 4,500 RPM. Unless a system reservoir utilized therewith were pressurized, this would amount to a practical limit on operational speed in order to limit input side bulk cavitation. Since the outer diameter of the Nichols Portland model 6170 gerotor set is 3 inches, this would suggest a rule of thumb limiting operational speeds for gerotor pumps utilizing radial porting to
Nₘₐₓ=4,500 Sqrt[3/d]RPM
where Nₘₐₓ is the maximum rotational speed inn RPM and Sqrt[3/d] is the square root of the ratio of 3 inches (e.g., the outer diameter of the 6170 gerotor set) divided by the outer diameter of the gerotor set in question.

Also taught in the fifth alternate preferred embodiment of the present invention is a method of reducing hydrodynamic bearing loading between an outer rotor 202 and any of the floating rings 102, 110, 116, 138, 152 and 212 described above, or 274, 300, 346 and 374 yet to be described, wherein fluid pressure within each pumping chamber 36 is conveyed radially outward in an appropriately selective manner. In the case of the gerotor set 204 this happens as a matter of course because pressurized fluid is conveyed through each radial face slot 200 to the space between the outer rotor 202 and any of the floating rings 212, 274, 300 and 374. As a matter of fact, pressurized fluid is even conveyed to the flat surfaces 108a and 108b in gerotor pump 210 via passage of the pressurized fluid through the face fluid commutation ports 214.

On the other hand, similar reduced hydrodynamic bearing loading between either outer rotor 18 or 184 and any of the floating rings 102, 110, 116, 138, 152, and 346 could be implemented by simply forming radial holes 226 connecting each pumping chamber 36 to the outside circular surface 228 of either of the outer rotors 18 and 184 as respectively shown in FIGS. 21A and 21B. This serves to convey pressurized fluid from the pumping chambers 36 to the space between either outer rotor 18 or 184 and any of the floating rings 102, 110, 116, 138, 152, and 346 in an appropriately selective manner.

Yet another factor with any of the gerotor pumps 10, 100, 130, 150, 180 or 210 is face leakage between the inner and outer rotors 14, and 18 or 202, respectively, and inner surfaces 58 and 64. It is important to maintain proper operating axial clearance at all times. If the clearance is too large, excessive leakage will occur thus reducing volumetric efficiency at higher pressures. If the clearance is too small, differential thermal expansion between the depth of any of gerotor cavities 26, 104, 136, 162 or 222 and the thickness of the gerotor set 12 or 204 could result in seizure at extreme temperature values. For instance, the housing 28 might be fabricated of aluminum and the gerotor set 12 or 204 fabricated of steel. In this case, differential thermal expansion could easily reduce axial clearance to zero and cause seizure at startup under very cold conditions. It is very difficult to control the appropriate dimensional tolerances such that the actual working gaps between the inner and outer rotors 14 and 18 or 202, and either of the inner surfaces 58 and 64 are maintained as required to effect minimal face leakage.

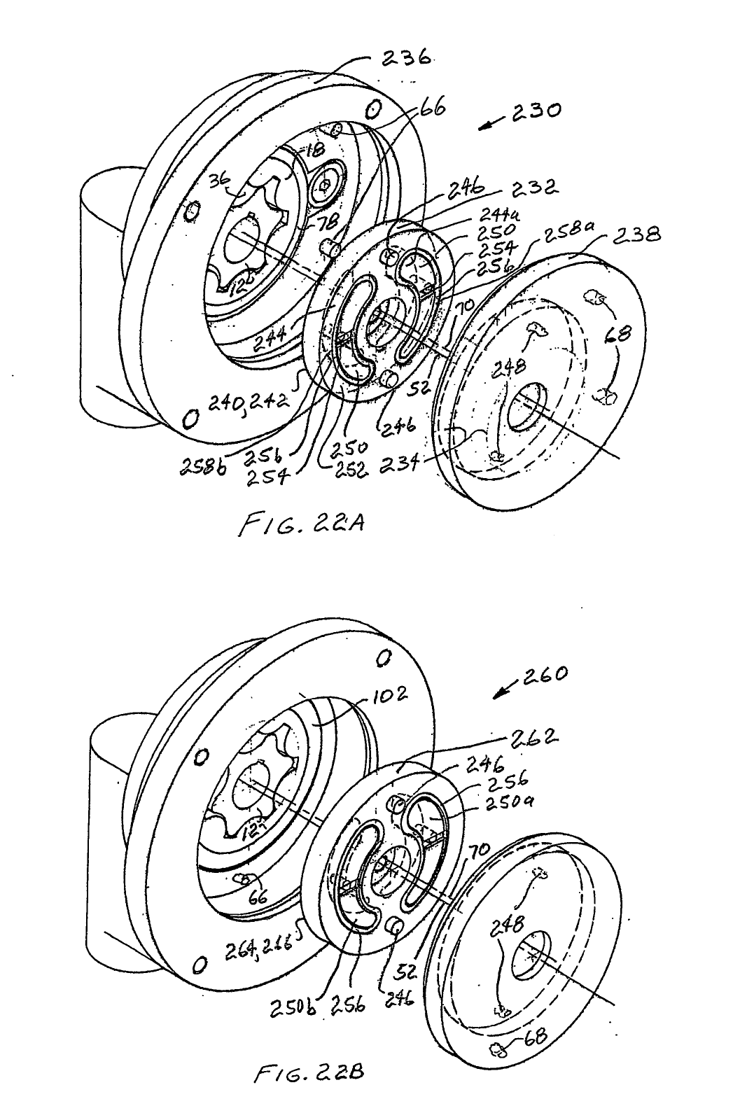

Shown in FIG. 22A is another improved gerotor pump 230 according to a sixth alternate preferred embodiment of the present invention. A pressure balancing plate 232 is inserted in a pocket 234 formed in either of housing 236 or in cover plate 238 as is depicted in FIG. 22A. For convenience, the gerotor pump 230 is shown as being derived from the gerotor pump 10. Only one pressure balancing plate 232 is shown in FIG. 22A. Mirror-imaged pressure balancing plates 232 could be inserted in mirror-imaged pockets 234 formed in both of the housing 236 and cover plate 238 just as well.

Again for convenience, the pressure balancing plate 232 is depicted in FIG. 22A as being formed in a circularly shaped manner with substantially the same diameter as the combination of outer rotor 18 and tire 78. In actuality, a pressure balancing plate 232 can be of any geometry so long as it substantially covers outer rotor 18. In any case, a facing side 240 thereof serves as one side of a gerotor cavity 242 in place of either of the inner surfaces 58 or 64 so used in the gerotor pump 10. If only one pressure balancing plate 232 is utilized, the axially oriented fluid commutation ports 72a and 72b are normally formed in the opposite side of the gerotor cavity, or in this case the housing 236. In addition however, shadow axially oriented fluid commutation ports 244a and 244b are usually formed in the opposing pressure balancing plate 232 in order to help balance the gerotor set 12 axially, reduce viscous losses and effectively double porting area (e.g., via fluid communicating through juxtaposed pumping chambers 36). In order to properly align the shadow axially oriented fluid commutation ports 244a and 244b with the axially oriented fluid commutation ports 72a and 72b, the pressure balancing plate 232 is selectively located with reference to the preferred eccentricity offset rotation axis 70 and therefore the preferred eccentricity axis 54 (not shown) via registration of aligning pins 246 in blind holes 248 formed in the cover plate 238. This of course also requires the use of alignment pins 66 to properly index the cover plate 238 as described above with reference to the gerotor pump 10.

In order to implement the balancing function of a pressure balancing plate 232, the shadow axially oriented fluid commutation ports 244a and 244b communicate fluidly with pressure balancing zones 250 located on the opposite side 252 of the pressure balancing plate 232 via bores 254 provided for that purpose. Areas of the pressure balancing zones 250 are determined by appropriately configured sealing rings 256 installed in grooves 258a and 258b theresurrounding. In cases where the axially oriented fluid commutation ports 72a and 72b are the ones formed in a pressure balancing plate 232, the bores 254 must additionally convey fluid between the axially oriented fluid commutation ports 72a and 72b and the housing ports 74a and 74b. In such cases, the bores 254 are enlarged and positioned in juxtaposition to the housing ports 74a and 74b in order to effectively convey the pump's delivery fluid flow.

Shown in FIG. 22B is another improved gerotor pump 260 also according to the sixth alternate preferred embodiment of the present invention. FIG. 22B depicts the gerotor pump 260 as being derived from the gerotor pump 100. Again this is for convenience only however, as either of the gerotor pumps 130 or 150 could have been so utilized as well. In any case, a slightly enlarged pressure balancing plate 262 is formed with substantially the same plan view shape and size as the floating ring 102. Then facing side 264 serves as the first side of a gerotor cavity 266. Again, two mirror-imaged pressure balancing plates 262 could be utilized. Further, the pressure balancing plate 262, or each one of mirror-imaged pressure balancing plates 262, is located with reference to both the preferred eccentricity offset rotation axis 70 and the preferred eccentricity axis 54 via the combination of aligning pins 246 and alignment pins 66 as explained above.

When urged toward a gerotor set 12 or 204, a pressure balancing plate 262 serves generally the same purpose of limiting face leakage as pressure balancing bearing blocks do in many gear pumps. However, the disc brake like tendency of such pressure balancing bearing blocks to drag on the surfaces of the gears in such a gear pump may be obviated by selectively forming the floating ring 102 slightly thicker than the gerotor set 12 or 204. Then the axial force provided initially by compression of the sealing rings 256 plus the axial force derived from pressure applied to either or both of the pressure balancing zones 250a and 250b maintains contact between the pressure balancing plate 262 and the floating ring 102, and the gerotor set 12 or 204 operates without any equivalent drag at a selected value of axial clearance therebetween.

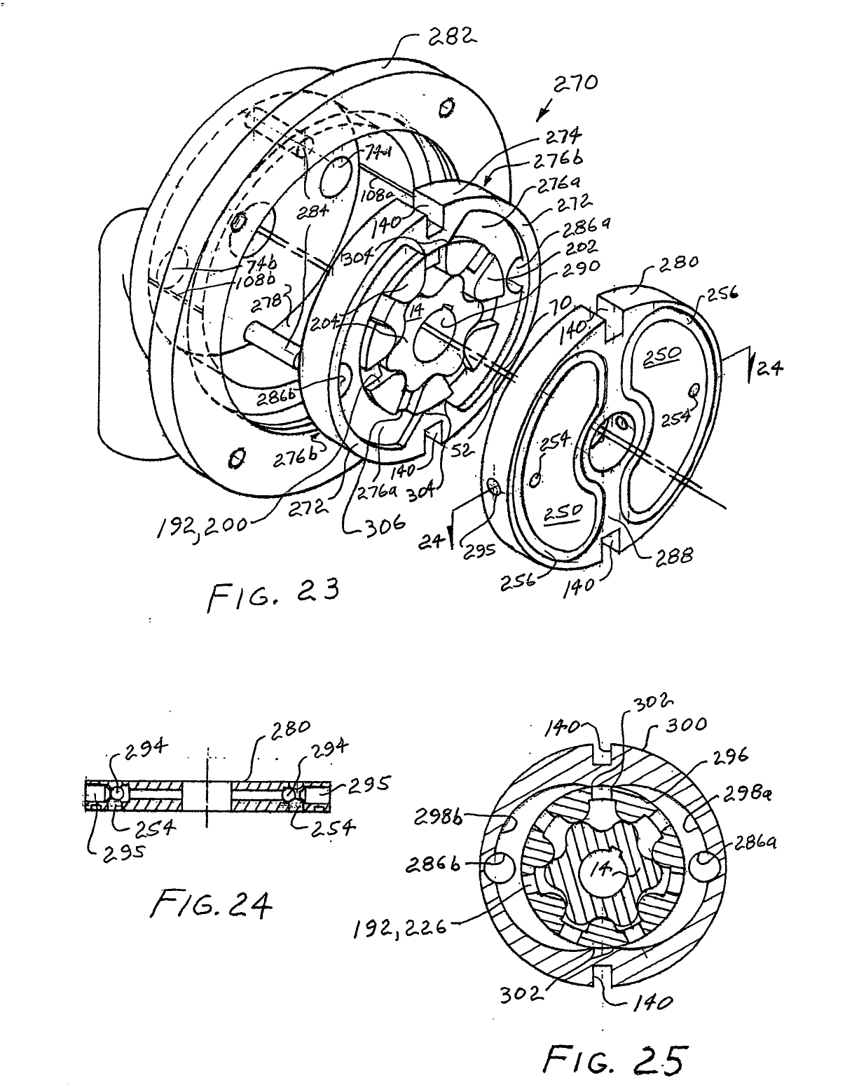

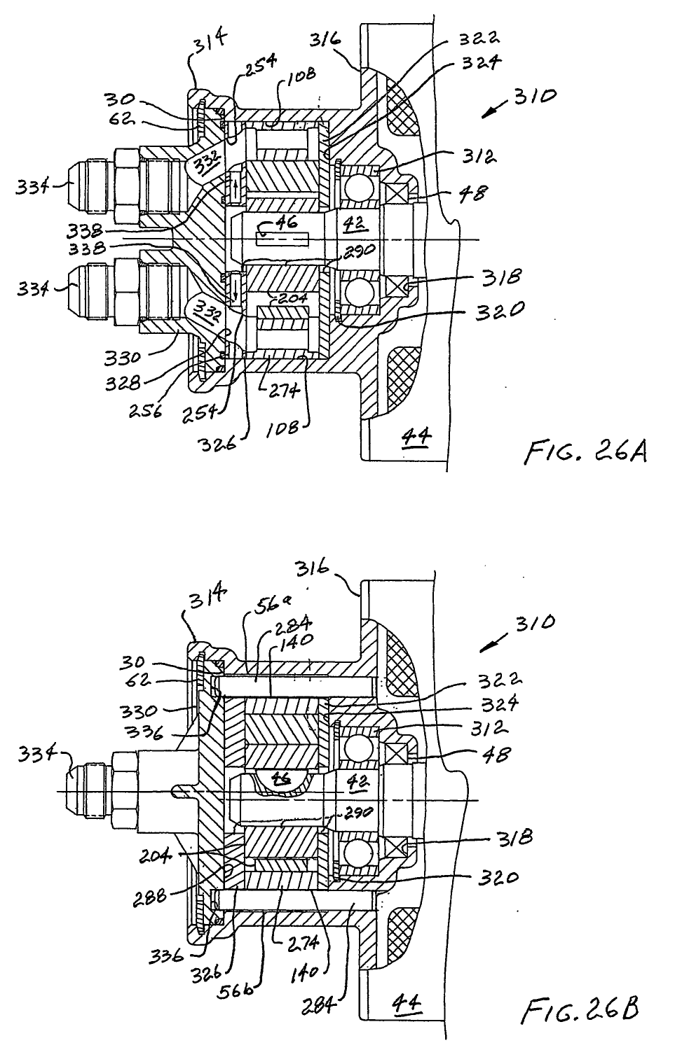

Shown in FIGS. 23 and 24 is yet another improved gerotor pump 270 also according to the sixth alternate preferred embodiment of the present invention. In this case, the teachings of the fifth alternate preferred embodiment as embodied by the gerotor pump 210 are co-mingled with the teachings of the sixth alternate preferred embodiment in providing the improved gerotor pump 270 with a combination of optimum porting and minimal face leakage. In this case, rims 272 are formed on either side of a modified floating ring 274. This results in face fluid commutation ports 276a and 276b (respectively formed on near and opposite sides) being substantially fluidly isolated from an axially extended gerotor pocket 278 when pressure balancing plate 280 is urged into contact with the floating ring 274. In this case the pressure balancing plate 280 is positioned within an extended portion of the gerotor pocket 278, but is urged toward the floating ring 274 by a combination of sealing rings 256 and pressurized fluid within pressure balancing zones 250 as explained above. Both the floating ring 274 and the pressure balancing plate 280 are rotationally indexed with respect to housing 282 by housing mounted pins 284. The transverse loading can be supported either via engagement of the housing mounted pins 284 with the slots 140, or via contact of the floating ring 274 on either of the flat surfaces 108a or 108b.

Fluid flowing from or to the face fluid commutation ports 276a passes through holes 286a and 286b formed in the floating ring 274. Passage of these fluid flows plus those flowing to or from the face fluid commutation ports 276b is provided by housing ports 74a and 74b.

As particularly depicted in FIG. 24, the improved gerotor pump 270 is easily configured as a bi-directional device by implementing check valves into the pressure balancing plate 280. This is done in order to continually vent the circumferential potions of the gerotor pocket 278, planar regions 288 and bores 290 to the lower pressure side of the gerotor pump 270. This is accomplished via nominally unrestricted fluid flow to either of passages 292 having an unseated ball 294 located against one of plugs 295, and then to and through the juxtaposed one of bores 254.

The teachings of the fifth and sixth embodiments can also be implemented in a modified version of the gerotor pump 270 as depicted in FIG. 25. In this case, the radial passages 192 are implemented as radial holes 226 formed in an outer rotor 296 wherein the holes 226 have been enlarged in order to minimize their fluid flow impedance. Fluid is conveyed to or from the radial holes 226 by fluid commutation port grooves 298a and 298b formed in a floating ring 300 to or from holes 286a and 286b. In this case, the outer surfaces of the floating ring 300 are formed in a planar manner similarly to the outer surfaces of floating rings 102, 110, 116, 138 and 152.

However, it is apparent that there would be some difficulties in implementing this particular version of the gerotor pump 270. Firstly, since all of the fluid must pass through the holes 286a and 286b (e.g., instead of half of the fluid as in the floating ring 274), loses therein would be higher. Furthermore, the severely reduced incidence angles of edges 302 of the fluid commutation port grooves 298a and 298b render it difficult to form spacing therebetween accurately equal to the width of the holes 226. Thus, it is apparent that maintaining precise port timing would be difficult. In counterpoint, this observation also implies that similar edges 304 of the face fluid commutation ports 276a and 276b could beneficially be formed parallel to the preferred eccentricity axis 54 (not shown). This would result in the distance therebetween not changing as a function of final forming operations of the inner bore 306 of the floating ring 274.

The Nichols Portland catalog suggests that a separate center plate fabricated in a similarly slightly thicker manner (e.g., than the gerotor set 12 or 204) be utilized in the same manner to limit face leakage. This is understood herein to be standard practice for prior art high pressure gerotor pumps. However, fabricating either of the gerotor pumps 260 or 270 with a floating ring 102, 274 or 300 and a pressure balancing plate 262 or 280 as depicted respectively in FIG. 22B or FIGS. 23, 24 and 25 is thought to be preferable herein because it is apparent that it is easier to guarantee proper fit and near zero relative temperature growth between the internally disposed gerotor set 12 or 204 and the respective floating ring 102, 274 or 300 than is possible in trying to match a gerotor set with a separate center plate as recommended by Nichols Portland. This is especially true if both the gerotor set 12 or 204 and respective floating ring 102, 274 or 300 are formed of the same material (i.e., steel). This is as opposed to a present art center plate (and housing) being fabricated from a different material (i.e., such as aluminum).

With reference now to FIGS. 26A and 26B, thereshown in sectional views taken in transverse and orthogonal planes is an exemplary improved gerotor pump 310 comprising various features presented in the first, second, fifth and sixth alternate preferred embodiments of the present invention. The gerotor pump 310 comprises a gerotor set 204 located within a floating ring 274. Deflections of the drive shaft 42 are minimized by locating a motor bearing 312 as close as possible to the gerotor set 204. This is accomplished by reversing the general layout of the improved gerotor pump 310 from any of those depicted hereinabove via forming housing 314 as a portion of motor end bell 316. As an additional benefit, transverse loading derived forces are then transferred to the motor bearing 312 and drive shaft 42 via a single structural element, namely the hosing/motor end bell 314/316.

In this case, the drive motor 44 includes the shaft seal 48 and the motor bearing 312 with the shaft seal 48 seated against a shoulder 318 and the motor bearing 312 being forcibly retained by a beveled retaining ring 320. The gerotor set 204 and floating ring 274 are located axially by a barrier plate 322 seated against shoulder 324. A pressure balancing plate 326 is positioned against the floating ring 274 but is urged theretoward by sealing rings 256 and pressure balancing zones 328 located in a cover plate 330. As before, the cover plate 330 is forcibly retained against shoulder 30 by beveled retaining ring 62. However, in this case the cover plate 330 comprises delivery ports 332 within which are mounted delivery fittings 334.

Proper angular indexing of the barrier plate 322, floating ring 274 and pressure balancing plate 326 is achieved via engagement of housing mounted pins 284 with slots 140 in each element while proper indexing of the cover plate 330 is achieved via engagement of the end of the housing mounted pins 284 with blind holes 336. However, transverse loading derived forces are mainly transmitted to the housing 314 via flat surfaces 108 while nominal orthogonal clearance for the floating 274 is provided as again indicated by numerical indicators 56a and 56b.

Bi-directional operation is enabled by check valves 338. As before, the check valve 338 instantly in fluidic communication with the lower port pressure vents the planar regions 288 and bores 290 to the lower pressure side of the gerotor pump 310. Because of the significantly enlarged and angularly disposed bores 254 in the pressure balancing plate 326, it is most convenient to utilize commercially available check valves such as an Axial Flow Lee Check valve available from The Lee company of Westbrook, Conn. for the check valves 338.

As implied by the above description of improved gerotor pump 310, features comprised in the gerotor pumps 10, 100, 130, 150, 180, 210, 230, 260 or 270 may be used singly or in combination to configure preferred gerotor pumps having selected performance characteristics along with minimal part count and optimum manufacturing economy. In some cases however, it is desirable to eliminate the reaction force (e.g., to transverse loading) hereinabove imposed on the drive shaft 42—even at the cost of slightly increased manufacturing costs. This would eliminate the lateral deflection noted above in the case of drive shaft 42. Further, because it would contain transverse loading within the pump structure it would allow utilization with a more nearly standard drive motor through simple spline shaft coupling means.

Therefore, in a seventh alternate preferred embodiment of the present invention, first and second types of universal gerotor pumps (e.g., as respectively embodied herein by first and second universal gerotor pumps 340 and 370 described below) are provided wherein a gerotor set, floating ring, two pressure balancing plates and an axle are combined in independent pumping cartridges. In general, the first type of universal gerotor pump comprises a two degree of freedom coupling (e.g., similar in operative nature to an Oldham coupling) for providing reaction torque (e.g., to the applied drive shaft torque) from its housing to its independent pumping cartridge while the second type of universal gerotor pump comprises an offset angular position constraint for providing the reaction torque. In either case, transverse loading is internally supported within the independent pumping cartridges. The inner rotors are supported via the axles that in turn are alternately supported by hydrodynamic bearings operatively formed between the axles and bores of the pressure balancing plates, or by sleeve or needle bearings mounted in the pressure balancing plates. Ideally, such universal gerotor pumps incorporate optimum porting as taught above in the fifth embodiment and outer rotors that are dominantly supported by pressurized fluid conveyed through radial face slots as also taught above in the fifth embodiment. However, in special cases the outer rotors could be supported within the floating ring by needle bearings instead of hydrodynamic bearings. This would be useful for implementing gerotor pumps wherein very slow and/or reversing operation is contemplated and it is desired to absolutely preclude breakaway characteristics otherwise resulting from Coulomb friction.

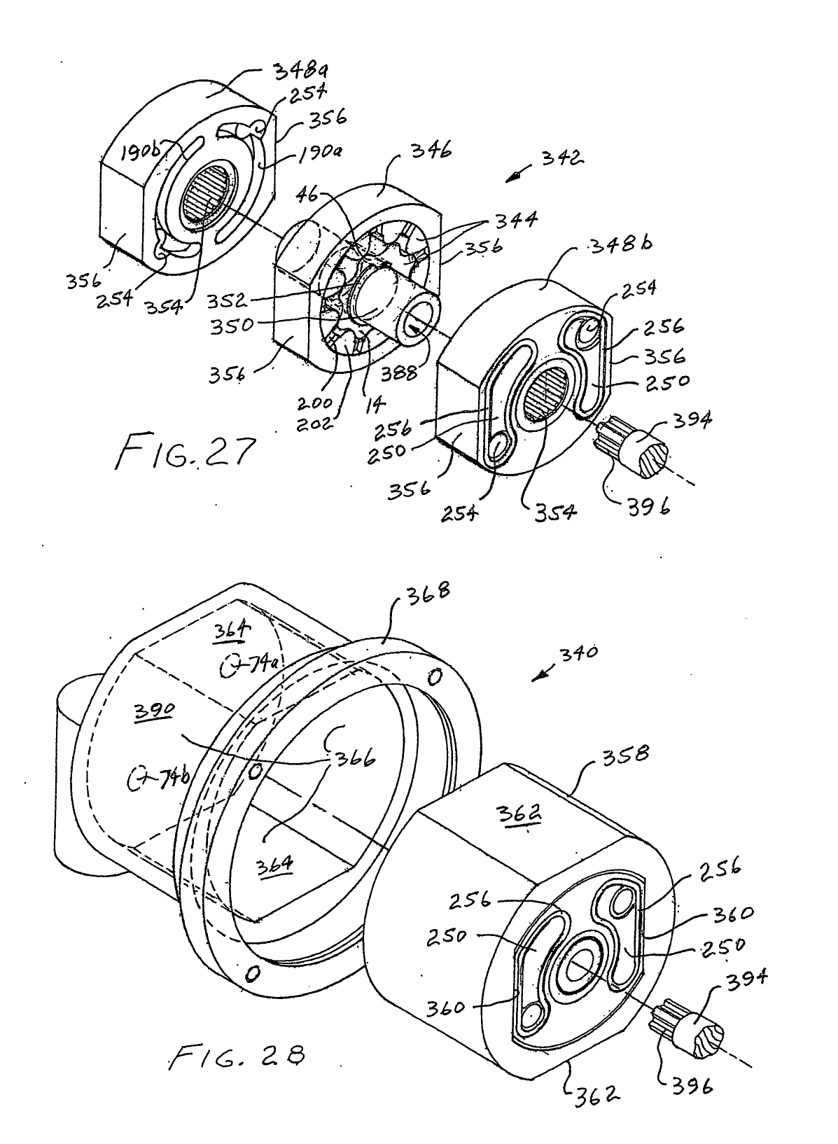

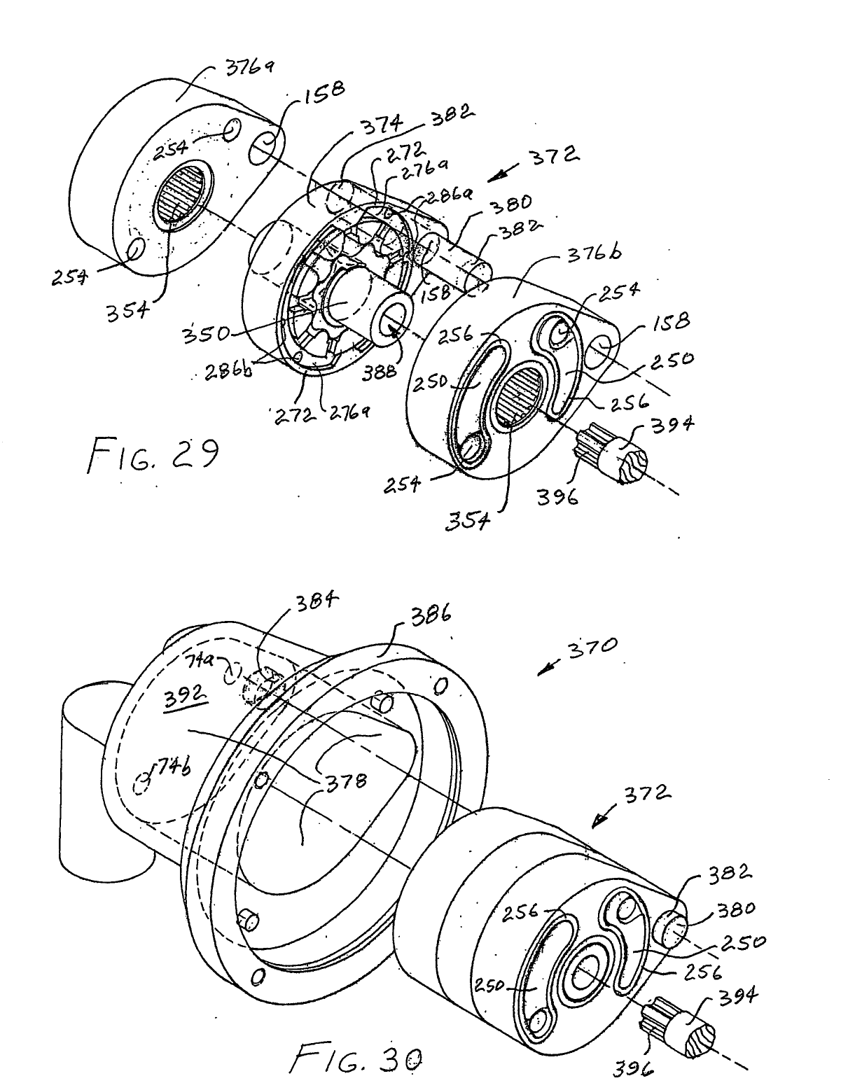

Specifically with reference now to FIGS. 27 and 28, thereshown in respective exploded isometric views are component parts of a first independent pumping cartridge 342 comprised in the first universal gerotor pump 340, and the universal gerotor pump 340 itself. The independent pumping cartridge 342 comprises a gerotor set 344, floating ring 346, two mirror-imaged pressure balancing plates 348a and 348b and an axle 350. The gerotor set 344 again comprises radial face slots 200 formed in an outer rotor 202. Further, the axle 350 is drivingly coupled to the inner rotor 14 of the gerotor set 344 via a Woodruff Key 46 and retained axially by retaining rings 352 located on either side of the inner rotor 14. Alternately, an integral axle and inner rotor (not shown) could be formed and interchangeably utilized. In any case, the axle 350 is in turn supported by needle bearings 354 mounted in the pressure balancing plates 348a and 348b.

In the independent pumping cartridge 342 the floating ring 346 and pressure balancing plates 348a and 348b are formed generally according to the teachings of the first and sixth alternate preferred embodiments as described above. In this case however, external flat surfaces 356 of the floating ring 346 and pressure balancing plates 348a and 348b are slidingly mounted within an intermediate ring 358 on internal opposing flat surfaces 360 thereof. Thus, opposing transverse loading derived forces in the floating ring 346 and the pressure balancing plates 348a and 348b are resisted by and confined within the intermediate ring 358. Then, orthogonal opposing external surfaces 362 of the intermediate ring 358 are slidingly mounted within orthogonal flat surfaces 364 formed in a modified gerotor pocket 366 formed in housing 368. Utilization of the respective interfacing external flat surfaces 356 and 362 on the floating ring 346, the pressure balancing plates 348a and 348b, and on the intermediate ring 358 are required in order to provide reaction torque necessary to support applied motor torque.

With further reference now to FIGS. 29 and 30, thereshown in respective exploded isometric views are component parts of a second independent pumping cartridge 372 comprised in the second universal gerotor pump 370, and the universal gerotor pump 370 itself. The independent pumping cartridge 372 comprises a floating ring 374, pressure balancing plates 376a and 376b and the axle 350 wherein the independent pumping cartridge 372 is formed generally according to the teachings of the third and sixth alternate preferred embodiments. As depicted in FIG. 29, the universal gerotor pump 370 also comprises radially oriented porting as utilized in the improved gerotor pump 270 described above. Rims 272 are again utilized to isolate face fluid commutation ports 276a and 276b from gerotor pocket 378. In this case, the overall size of the independent pumping cartridge 372 is minimized by providing multiple smaller holes 286a and 286b fluidly coupling the face fluid commutation ports 276a and 276b.

In the second universal gerotor pump 370 a pin 380 serves to tie the floating ring 374 and pressure balancing plates 376a and 376b together. Transverse loading is thus supported within the independent pumping cartridge 372 via the pin 380. However, the pin 380 is formed longer than the combined axial length of the assembled floating ring 374 and pressure balancing plates 376a and 376b. Then the reaction torque necessary to support the applied motor torque is provided by the ends 382 of the pin 380 extending beyond the independent pumping cartridge 372 and engaging oblong slots 384 formed in each of a housing 386 and/or a cover plate (not shown).

In the universal gerotor pumps 340 and 370, the respective independent pumping cartridges 342 and 372 are held together axially by near proximity to and between respective flat surfaces 390 and 392 of the housings 368 and 386 and an opposing internal flat surface of the cover plate by sealing rings 256 and pressure applied to the pressure balancing zones 250 as taught in the sixth embodiment. A drive shaft 394 utilized in place of the drive shaft 42 does not have to support transverse loading derived forces and therefore comprises a spline 396 in place of a second Woodruff key 46 for transmitting driving torque to a centrally disposed female spline 388 (e.g., as indicated in Pigs. 27 and 29) within the axle 350. Although the drive shaft 394 is free of transverse loading it is considered preferable herein to locate the female spline 388 centrally within the axle 350 and thus in transverse planar alignment with either of the floating rings 346 or 374.

Thus in either of the first or second universal gerotor pumps 340 or 370, the outer rotor 202, and floating ring 346 or 374 are able to float with reference to the inner rotor 14 and axle 350 as previously taught. In addition, the independent pumping cartridges 342 and 372 as a whole are able to float with reference to drive shaft 394. No transverse loading is present in the first universal gerotor pump 340 while the only transverse loading applied to drive shaft 394 by the independent pumping cartridge 372 in the second universal gerotor pump 370 is an equal and oppositely directed reaction force to that applied to the ends 382 of the pin 380 as a result of the applied motor torque.

Housing ports 74a and 74b may be located either in the housing 368 or 386, or in the cover plate and are coupled to the juxtaposed set of curved slot shaped fluid commutation ports 190a and 190b or face fluid commutation ports 276b via appropriate bores 254 as described above with reference to the sixth alternate preferred embodiment.

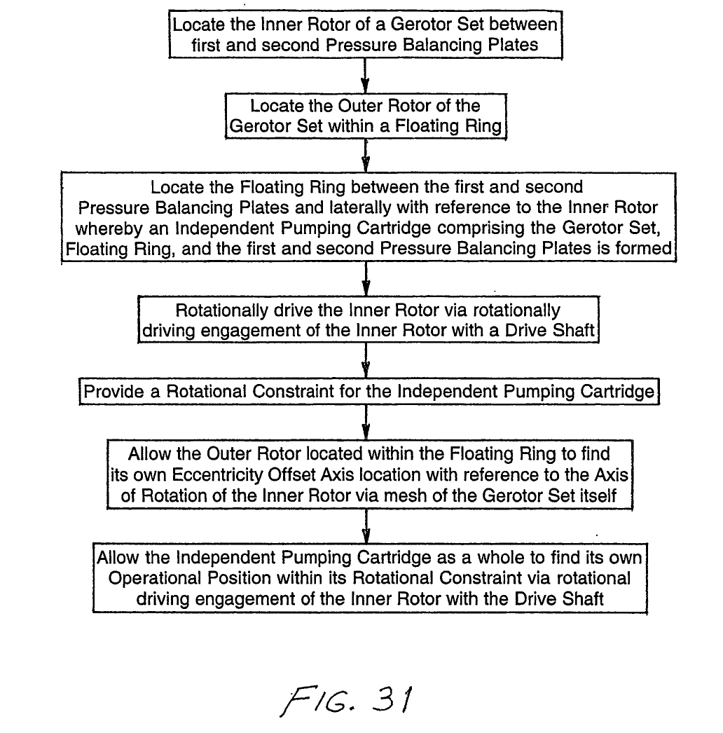

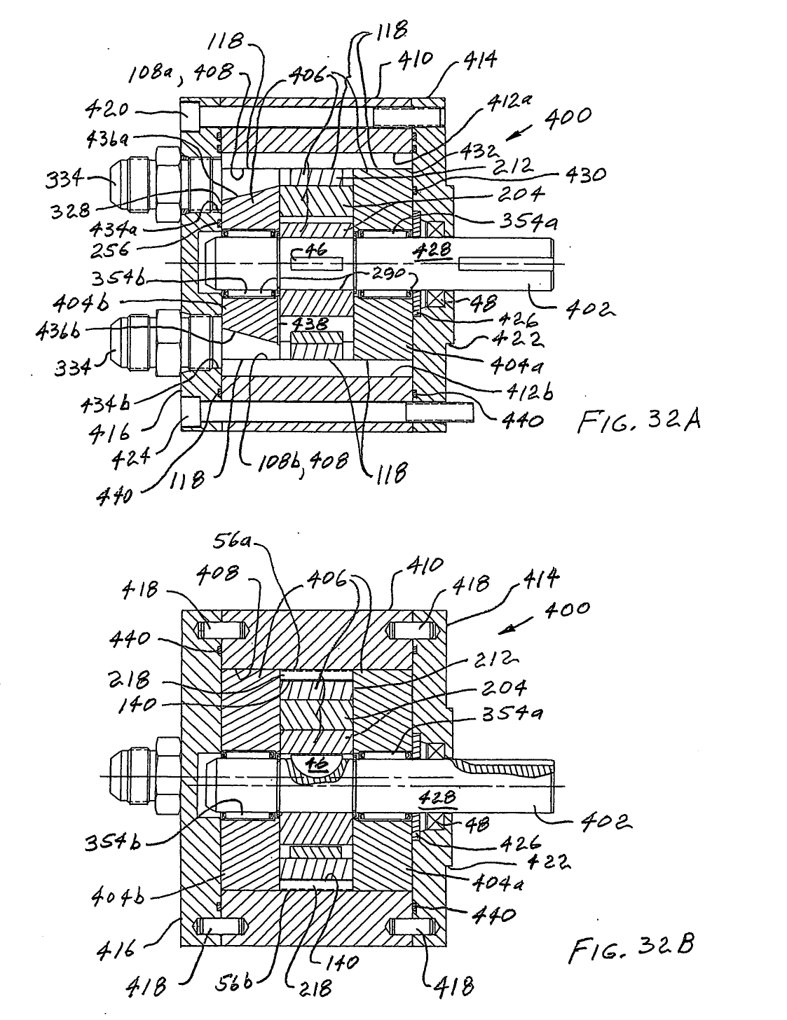

A third improved method of supporting gerotor sets comprised in gerotor pumps has been additionally enabled by the seventh embodiment of the present invention. As depicted in FIG. 31, this method comprises the steps of locating the inner rotor of a gerotor set between first and second pressure balancing plates; locating the outer rotor of the gerotor set within a floating ring; locating the floating ring between the first and second pressure balancing plates and laterally with reference to the inner rotor whereby an independent pumping cartridge comprising the gerotor set, floating ring, and the first and second pressure balancing plates is formed; rotationally driving the inner rotor via rotationally driving engagement of the inner rotor with a drive shaft;

providing a rotational constraint for the independent pumping cartridge, allowing the outer rotor located within the floating ring to find its own eccentricity offset rotation axis location with reference to the axis of rotation of the inner rotor via mesh of the gerotor set itself; and allowing the independent pumping cartridge as a whole to find its own operational position within its single tangential constraint via the rotationally driving engagement of the inner rotor with the drive shaft.

All of the improved gerotor pumps described hereinabove have either been depicted in conjunction with a fully integrated drive motor 44, or as being adapted for receiving an integrated drive motor 44. However, teachings of the preferred and various alternate preferred embodiments of the present invention can of course also be utilized to configure similarly improved stand-alone gerotor pumps. Therefore, with reference now to FIGS. 32A and 32B, thereshown in sectional views taken in transverse and orthogonal planes is an exemplary improved stand-alone gerotor pump 400 comprising various features presented above in the first, fifth, sixth and seventh alternate preferred embodiments of the present invention. The stand-alone gerotor pump 400 comprises a gerotor set 204 located within a floating ring 212. This time however, deflections of pump shaft 402 are minimized by locating supporting needle bearings 354a and 354b in respective front and rear bearing blocks 404a and 404b disposed on either side of the floating ring 212 and gerotor set 204 in a similar manner to that depicted in either of independent pumping cartridges 342 and 372.

In general terms, the stand-alone gerotor pump 400 is configured similarly to many known gear pumps wherein a sub-assembly 406 comprising the front and rear bearing blocks 404a and 404b, floating ring 212 and gerotor set 204 is slidingly positioned within a bore 408 formed in a housing 410. The bore 408 has laterally disposed flat surfaces 108a and 108b with respective central relief output and input passages 412a and 412b formed similarly to the manner in which housing ports 216a and 216b penetrate the nominal centers of the flat surfaces 108a and 108b in the housing 224 depicted in FIG. 18. Close fitting opposing flats 118 are again formed on the front and rear bearing blocks 404a and 404b, as well as on the floating ring 212. The front and rear bearing blocks 404a and 404b are formed such that they are generally close fitting all around within the bore 408. Thus, fluid is effectively precluded from passage therearound. However, the floating ring 212 is formed slightly smaller in the orthogonal direction whereby clearance therefor is again provided as indicated by numerical indicators 56a and 56b. Thus, the slots 140 and pins 218 are again required in order to preclude passage of fluid from one side of the floating ring 212 to the other as shown in FIGS. 19A and 19B.

As before, the floating ring 212 is formed very slightly longer than the gerotor set 204 whereby the gerotor set 204 is completely free to rotate therein even when the front and rear bearing blocks 404a and 404b are forcibly placed in contact with the floating ring 212. The housing 410, in turn, is similarly formed slightly longer than the combined axial lengths of the front bearing block 404a, floating ring 212 and rear bearing block 404b. Thus, when respective front and rear cover plates 414 and 416 are located by dowel pins 418 and forcibly retained on either end of the housing 410 by multiple bolts 420 (one shown), slight axial movement of the sub-assembly 406 is still possible.

The front cover plate 414 serves as the mounting surface for the stand-alone gerotor pump 400. A pilot boss 422 is provided and multiple bolts 424 (again—one shown) are utilized in mounting the stand-alone gerotor pump 400. Forward migration of the needle bearing 354a is precluded by retainer plate 426. In addition, a shaft seal 48 is mounted within the front cover plate 414 for sealing the input end 428 of the pump shaft 402. In this exemplary case, the stand-alone gerotor pump 400 is configured as a unidirectional pump whereby an O-ring seal 430 is used to limit high pressure fluid to the area 432 immediately surrounding the front end of the output relief passage 412a.

The rear cover plate 416 comprises respective output and input ports 434a and 434b within which are mounted delivery fittings 334. The rear bearing block 404b comprises relief slots 436a and 436b for enabling restriction free fluid passage from or to respective relief passages 412a and 412b as well as respective face fluid commutation ports 214. A sealing ring 256 is mounted in the rear cover plate 416 and defines a pressure balancing zone 328 between the rear cover plate 416 and the rear bearing block 404b. Output fluid pressure forces the sub-assembly 406 together and urges it toward the front cover plate 414. Input fluid pressure is conveyed to the bores 290 from the relief slot 436b in a standard manner by face slot 438. Finally, seepage fluid is eliminated by O-ring seals 440.

Again, the gerotor pumps 10, 130, 150, 180, 210, 230, 260, 270, 310, 340, 370 and 400, possess numerous advantages over gerotor pumps configured according to the present art. The primary advantages relate to providing gerotor pumps of simplified design having an additional degree of freedom whereby their outer rotors can find their own optimum centers of rotation, and further, wherein fewer precision parts and precision location features are required. Further advantages include providing adjustment means for enabling smooth and quite running of uni-directional gerotor pumps under load, providing improved critical part location constraints for enabling smooth and quite running of bi-directional gerotor pumps, and providing internal means for setting required minimal axial clearance between the gerotor set and the first and second sides of the gerotor cavity of gerotor pumps.

With reference now to FIG. 33, thereshown is a plan view depicting an assembled gerotor set 450 illustrating (e.g., in an exaggerated manner) working clearance typically formed in prior art gerotor sets 450 at a nominal lobe-to-lobe contact point 452 (hereinafter “contact point 452”) nearest an out-of-mesh position 454. The gerotor set 450 is symmetrically disposed about an eccentricity axis 456 whereby differential fluid pressure can be produced in a known manner between either side of the eccentricity axis 456 in a gerotor pump (not shown) when a gerotor set 450 comprised therein is caused to rotate via torque applied to inner rotor 458 by a prime mover such as an electric motor (also not shown). During a significant portion of rotation of the gerotor set 450, an actual lobe-to-groove contact point 460 (hereinafter “contact point 460”) nearest an in-mesh position 462 results from transmission of torque from inner rotor 458 to outer rotor 464 as the inner rotor 458 is driven. The fluid pressure is differentially applied across both contact points 452 and 460 whereby a leakage path 466 proximate to contact point 452 and an intermittent leakage path 468 proximate to contact point 460 are formed.

Operational volumetric efficiency is significantly limited by tip leakage through leakage path 466 and to a lesser extent through leakage path 468. This is because relatively large working clearance values are usually experienced as a result of limitations of prior art fabrication methods. Typically such fabrication methods involve utilization of powdered metal technology wherein diametral clearance values of perhaps 0.003 inch between contact points 452 and 460 are generally experienced. Clearly, such tip leakage would be significantly reduced via significantly reducing the diametral clearance between the contact points 452 and 460.

In order for any of the above described gerotor pumps to realize higher pressure output values it is of course imperative that this diametral lobe-to-lobe and lobe-to-groove clearances be significantly reduced. This is achieved in methods for re-contouring lobe tip regions of inner and/or outer rotors of gerotor sets according to any of the eighth, ninth and tenth alternate preferred embodiments of the present invention as presented below. In general, these methods entail initially forming only the tip regions of either or both of the outwardly extending lobes of the inner rotor and/or the inwardly extending lobes of the outer rotor in a slightly enlarged manner and then re-forming the tip regions as desired.

These methods are possible because close inspection of portions of outwardly extending lobes 470 of the inner rotor 458 and inwardly extending lobes 472 of the outer rotor 464 nearest the out-of-mesh position 454 reveal that only the respective extreme tip regions 474 and 476 thereof are involved in forming contact point 452. Reducing working clearance between the tip regions 474 and 476 alone would significantly reduce diametral clearance along the eccentricity axis 456 generally present in prior art gerotor sets 450, thereby significantly narrowing leakage paths 466 and 468, and thus significantly reducing tip leakage.

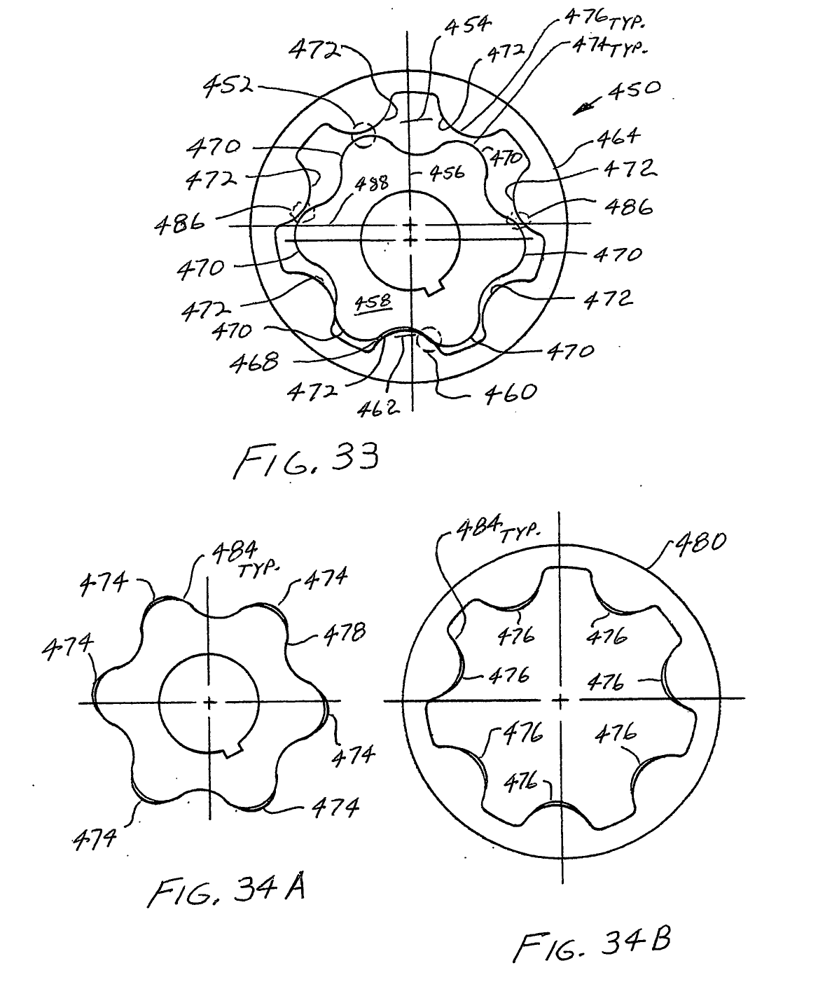

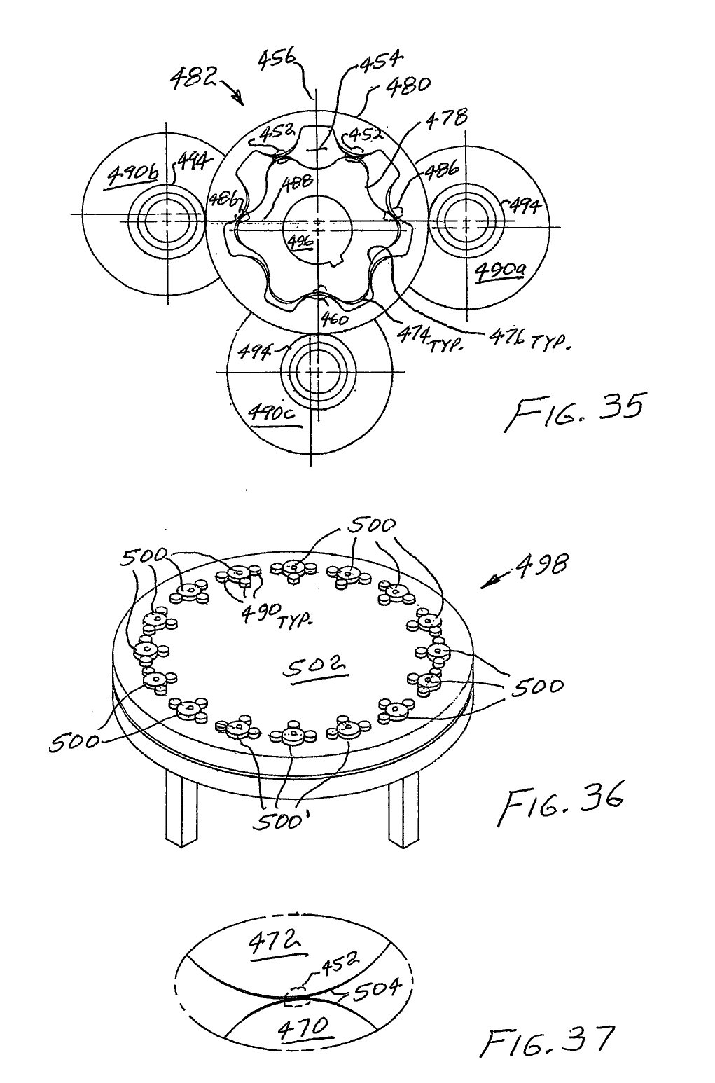

In greater detail, re-contouring methods are presented in the eighth, ninth and tenth alternate preferred embodiments wherein either or both tip regions 474 and 476 of respective modified inner and outer rotors 478 and 480 are initially formed in a slightly enlarged manner (i.e., such as during the powdered metal technology manufacturing process mentioned above) as shown in respective plan views presented in an exaggerated manner in FIGS. 34A and 34B. The tip regions 474 and 476 are formed such that line-to-line contact, or even an actual interference, would occur at the contact points 452 and 460 if resulting gerotor sets 482 were forced together. However, care is taken to effect smooth transitions to normal and thus greater clearance values for the remaining portions 484 of the lobe contours. This is done such that clearance values at contact points 486 nearest an orthogonal lateral axis 488 are slightly greater than the maximum interference values possible at contact points 452 and 460.

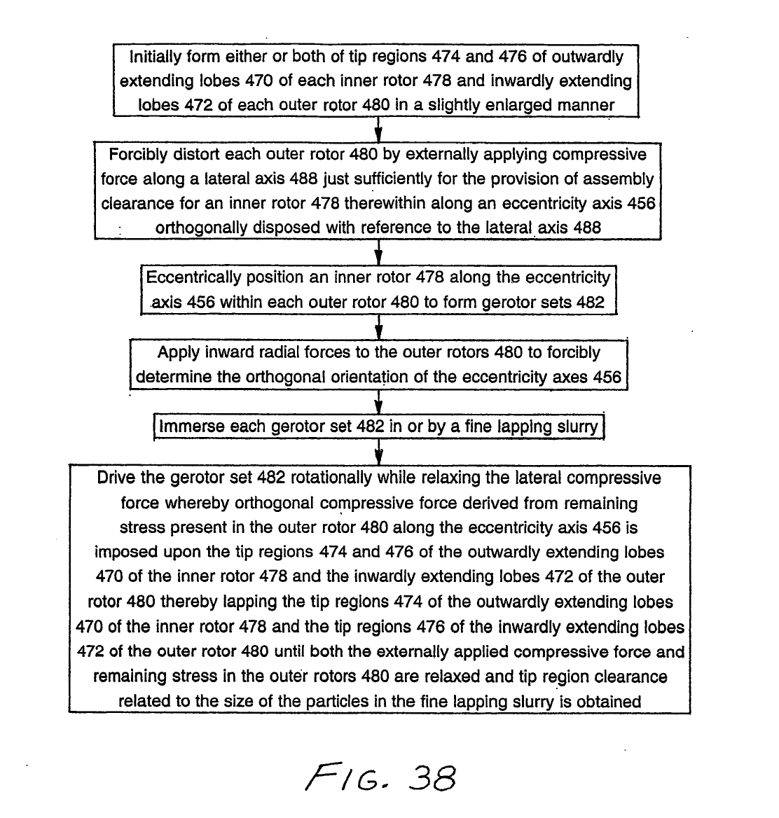

A method for forming conjugately-generated tip regions of inner and outer rotors utilized in gerotor sets is presented in the eighth alternate preferred embodiment of the present invention. As depicted in FIG. 35, outer rotors 480 are forcibly distorted by opposing lateral compressive forces (e.g., with respect to the eccentricity axis 456) applied along lateral axis 488 by first and second displacement means 490a and 490b. The displacement means 490a and 490b can take any convenient form of course. Herein they are depicted in FIG. 35 as being torque motor driven eccentric arrangements comprising torque motors 492 and cam followers 494. Utilization of a compliant device such as a torque motor 492 for generating a known displacement inducing force is believed preferable herein to attempting to implement a rigid absolute displacement means because of difficulties likely to be experienced in accurately effecting the small displacement values involved with such a rigid absolute displacement means. In actuality, either of the torque motors 492 (i.e., the torque motor 492 utilized in displacement means 490a) is driven to an adjustable stop (not shown) in order to position its cam follower 494 suitably for positioning the distorted outer rotor 480 in a nominally symmetric manner with reference to inner rotor drive spindle 496. Utilization of cam followers 494 is necessary in order to allow for rotation of the outer rotors 480 relative to the displacement means 490a and 490b. Care is taken to apply force (i.e., from displacement means 490b) just sufficient for the provision of assembly clearance for inner rotors 478 along the eccentricity axis 16. This allows for assembly of an inner rotor 478 because, as noted above, there is still adequate clearance at the contact points 486.

In any case, an inner rotor 478 is eccentrically positioned along the eccentricity axis 456 within each stressed outer rotor 480. In addition, the cam follower 494 of a third displacement means 490c is forcibly applied in juxtaposition to the contact point 460 along the eccentricity axis 456. This force is applied through the contact point 460 and inner rotor 458 to the inner rotor drive spindle 496. The result is a continuing orthogonal relationship between eccentricity and lateral axes 456 and 488 during an ensuing lapping operation.

Finally, the gerotor sets 482 are immersed within or by a fine lapping slurry and lapping is begun. This can be effected by either rotationally driving the inner rotor spindle 496 as depicted in FIG. 35, or alternately, by holding either of the inner or outer rotors 478 or 480 stationary and orbitally driving the other (e.g., where holding the outer rotor 480 stationary implies still permitting limited radial motions thereof while all of the displacement means 490 are rotated). Of these possibilities, driving the inner rotor 478 and leaving the orthogonal eccentricity and lateral axes 456 and 488 in a fixed position is believed herein to be the most practical. Fixedly positioning either of the inner or outer rotors 478 or 480 and orbitally driving the other by concomitantly rotating all three of the displacement means 490 along with allowing the other rotor 480 or 478 to move orbitally is certainly possible, but is believed herein to be much more difficult.

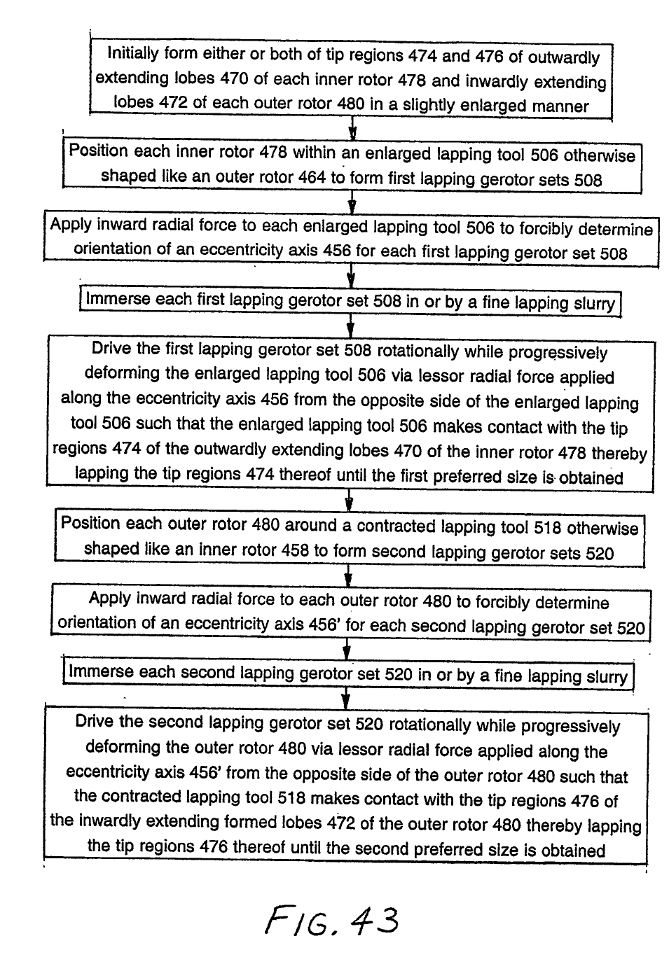

For that reason, the methods described below for forming conjugately-generated tip regions of inner and outer rotors utilized in gerotor sets depicted in the flow chart of FIG. 38, or for “zone” size re-contouring tip regions of lobes of rotors for matching conjugate rotors formed in a standard manner depicted in the flow chart of FIG. 41, or for re-contouring tip regions of inner and outer rotors in conformity with respective standardized first and second preferred sizes depicted in the flow chart of FIG. 43 describe execution of the lapping step via rotationally driving the inner rotor spindle 496 as depicted in FIG. 35. This is not intended to be limiting however, as lapping via orbitally driving either of the inner or outer rotors clearly falls within the scope of the invention.

In any case, as the lapping progresses, torque applied by the lateral compressive force by displacement means 490a and 490b is progressively relaxed whereby compressive force is imposed upon those tip regions 474 and 476 near the out-of-mesh positions 454 as a function of remaining stress present in the outer rotors 480. The lapping operation continues until both the compressive force and the remaining stress in the outer rotors 480 are totally relaxed whereupon working tip clearances at contact points 452 and 460 achieve values related to the size of particles in the fine lapping slurry. Finally, the re-contoured gerotor sets 482 are removed from the fine lapping slurry and cleaned. Then the re-contoured gerotor sets 482 are utilized as gerotor sets comprising mated inner and outer rotors 478 and 480. Thus, gerotor sets 482 are re-contoured according to the preferred embodiment of the present invention and can in fact be said to be conjugately-generated.

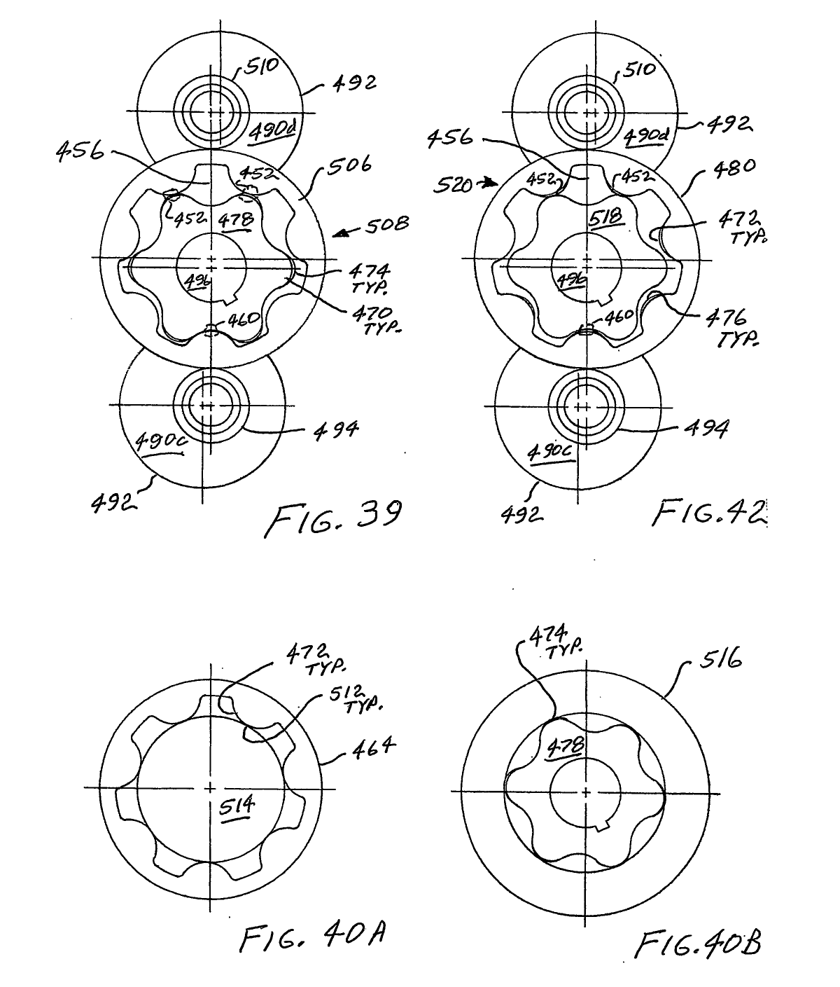

With reference now to FIG. 36, thereshown is a slowly rotating dial automatic machine 498 comprising a multitude of stations 500 each including displacement means 490a, 490b and 490c. Those stations 500′ instantly proximate to unloading and loading positions are respectively so utilized for loading untapped and finish lapped conjugately-generated gerotor sets 482. As the dial automatic machine 498 moves rotationally, all of the displacement means 490 and spindle drive mechanisms (e.g., located under table top 502 along with the torque motors 492) execute their operational lapping cycles as described above. A finish lapped contact point 452 and the area immediately theresurrounding are depicted in a magnified manner in FIG. 37 wherein remaining enlarged portions of the lobes 470 and 472 are indicated by shaded areas 504.

The method for forming conjugately-generated tip regions of inner and outer rotors utilized in gerotor sets then is depicted in the flow chart of FIG. 38 wherein, either or both of tip regions 474 and 476 of outwardly extending lobes 470 of each inner rotor 478 and inwardly extending lobes 472 of each outer rotor 480 are initially formed in a slightly enlarged manner; each outer rotor 480 is forcibly distorted by externally applying compressive force along a lateral axis 488 just sufficiently for the provision of assembly clearance for an inner rotor 478 therewithin along an eccentricity axis 456 orthogonally disposed with reference to the lateral axis 488; an inner rotor 478 is eccentrically positioned along the eccentricity axis 456 within each outer rotor 480 to form gerotor sets 482; inward radial forces are applied to the outer rotors 480 to forcibly determine the orthogonal orientation of the eccentricity axes 456; each gerotor set 482 is immersed in or by a fine lapping slurry; and the gerotor set 482 is rotationally driven while the lateral compressive force is relaxed whereby orthogonal compressive force derived from remaining stress present in the outer rotor 480 along the eccentricity axis 456 is imposed upon the tip regions 474 and 476 of the outwardly extending lobes 470 of the inner rotor 478 and the inwardly extending lobes 472 of the outer rotor 480 thereby lapping the tip regions 474 of the outwardly extending lobes 470 of the inner rotor 478 and the tip regions 476 of the inwardly extending lobes 472 of the outer rotor 480 until both the externally applied compressive force and remaining stress in the outer rotors 480 are relaxed and tip region clearance related to the size of the particles in the fine lapping slurry is obtained.

A method for “zone” size re-contouring tip regions of lobes of inner rotors for matching outer rotors formed in a standard manner is presented in the ninth alternate preferred embodiment of the present invention. As depicted in FIG. 39, this method involves lapping of only the tip regions 474 of the outwardly extending lobes 470 of the inner rotors 478 whereby only they are initially formed in a slightly enlarged manner as described above. In this case, the inner rotors 478 are positioned within enlarged lapping tools 506 that just clear the outwardly extending lobes 470 of the inner rotors 478 but are otherwise shaped like an outer rotor 464 to form first lapping gerotor sets 508. Only the third displacement means 490c are used for forcibly creating contact points 460 between the enlarged lapping tools 506 and the inner rotors 478. This is done in order to determine orientation of eccentricity axes 456 for the first lapping gerotor sets 508. Next the first lapping gerotor sets 508 are immersed within or by a fine lapping slurry and either rotated, or the enlarged lapping tools 506 or inner rotors 478 orbitally driven, while the enlarged lapping tools 506 are progressively deformed by lesser inward radial forces applied along the eccentricity axes 456 from the opposite sides of the enlarged lapping tools 506 by cam followers 510 comprised in a fourth displacement means 490d such that they establish actual contact points 452 and progressively lap tip regions 474 until desired inner rotor geometries are obtained.

Again, this method has been described with reference to “zone” size re-contouring tip regions of lobes of inner rotors for matching outer rotors formed in a standard manner with reference to the first lapping gerotor sets 508 as depicted in FIG. 39. Clearly, the method could have been described with reference to “zone” size re-contouring tip regions of lobes of outer rotors for matching inner rotors formed in a standard manner with reference to the second lapping gerotor sets 520 as depicted in FIG. 42 and described below. Such an alternate method clearly falls within the scope of the invention as well.

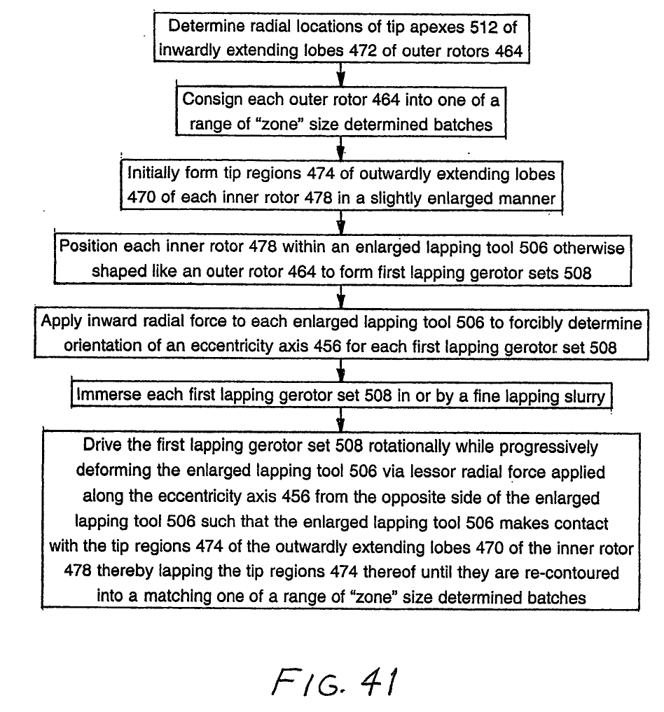

In this case, the desired inner rotor geometries must be determined by accurate gaging methods. For instance, as depicted in FIG. 40A, the radial location of the tip apexes 512 of the inwardly extending lobes 472 of outer rotors 464 could be determined via utilization of plug go/no go gages 514 whereby they are separated into “zone” size determined batches and then the inner rotors 478 are lapped as described above until they are re-contoured into mating “zone” size determined batches as determined by ring go/no go gages 516 as depicted in FIG. 40B.

The method for “zone” size re-contouring tip regions of lobes of inner rotors for matching outer rotors formed in a standard manner is depicted in the flow chart of FIG. 41, wherein radial locations of tip apexes 512 of inwardly extending lobes 472 of outer rotors 464 are determined; each outer rotor 464 is consigned into one of a range of “zone” size determined batches; tip regions 474 of outwardly extending lobes 470 of each inner rotor 478 are initially formed in a slightly enlarged manner; each inner rotor 478 is positioned within an enlarged lapping tool 506 otherwise shaped like an outer rotor 464 to form first lapping gerotor sets 508; inward radial force is applied to each enlarged lapping tool 506 to forcibly determine orientation of an eccentricity axis 456 for each first lapping gerotor set 508; each first lapping gerotor set 508 is immersed in or by a fine lapping slurry; and the first lapping gerotor set 508 is rotationally driven while the enlarged lapping tool 506 is progressively deformed via lesser radial force applied along the eccentricity axis 456 from the opposite side of the enlarged lapping tool 506 such that the enlarged lapping tool 506 makes contact with the tip regions 474 of the outwardly extending lobes 470 of the inner rotor 478 thereby lapping the tip regions 474 thereof until they are re-contoured into a matching one of a range of “zone” size determined batches.

A method for re-contouring tip regions of inner and outer rotors in conformity with respective standardized first and second preferred sizes is presented in the tenth alternate preferred embodiment of the present invention.

This method involves lapping of the tip regions 474 of the outwardly extending lobes 470 of inner rotors 478 to a first preferred size, and lapping the tip regions 476 of the inwardly extending lobes 472 of outer rotors 480 to a second and mating preferred size. In this case, the tip regions 474 of the outwardly extending lobes 470 of the inner rotors 478 are lapped in exactly the same manner as described above with reference to FIG. 39 until the first preferred size is obtained. Additionally however, the outer rotors 480 are positioned around contracted lapping tools 518 that just clear the inwardly extending lobes 472 of the outer rotors 480 but are otherwise shaped like an inner rotor 458 to form second lapping gerotor sets 520 as depicted in FIG. 42. Then inward radial forces are applied to the outer rotors 480 to forcibly form contact points 460 and thus determine orientation of eccentricity axes 456 for the second lapping gerotor sets 520. Next the second lapping gerotor sets 520 are immersed in or by a fine lapping slurry and either rotated, or the contracted lapping tools 518 or outer rotors 480 orbitally driven, while the outer rotors 480 are progressively deformed by lesser inward radial forces applied along the eccentricity axes 456 from the opposite sides of the outer rotors 480 such that the contracted lapping tools make contact with the tip regions 476 of the inwardly extending lobes 472 of the outer rotors 480 and progressively lap those tip regions 476 until the second preferred size is obtained.

The method for re-contouring tip regions of inner and outer rotors in conformity with respective standardized first and second preferred sizes is depicted in the flow chart of FIG. 43, wherein either or both of tip regions 474 and 476 of outwardly extending lobes 470 of each inner rotor 478 and inwardly extending lobes 472 of each outer rotor 480 are initially formed in a slightly enlarged manner; each inner rotor 478 is positioned within an enlarged lapping tool 506 otherwise shaped like an outer rotor 464 to form first lapping gerotor sets 508; inward radial force is applied to each enlarged lapping tool 506 to forcibly determine orientation of an eccentricity axis 456 for each first lapping gerotor set 508; each first lapping gerotor set 508 is immersed in or by a fine lapping slurry; the first lapping gerotor set 508 is rotationally driven while the enlarged lapping tool 506 is progressively deformed via lesser radial force applied along the eccentricity axis 456 from the opposite side of the enlarged lapping tool 506 such that the enlarged lapping tool 506 makes contact with the tip regions 474 of the outwardly extending lobes 470 of the inner rotor 478 thereby lapping the tip regions 474 thereof until the first preferred size is obtained; each outer rotor 480 is positioned around a contracted lapping tool 518 otherwise shaped like an inner rotor 458 to form second lapping gerotor sets 520; inward radial force is applied to each outer rotor 480 to forcibly determine orientation of an eccentricity axis 456′ for each second lapping gerotor set 520; each second lapping gerotor set 520 is immersed in or by a fine lapping slurry; and the second lapping gerotor set 520 is rotationally driven while the outer rotor 480 is progressively deformed via lesser radial force applied along the eccentricity axis 456′ from the opposite side of the outer rotor 480 such that the contracted lapping tool 518 makes contact with the tip regions 476 of the inwardly extending formed lobes 472 of the outer rotor 480 thereby lapping the tip regions 476 thereof until the second preferred size is obtained.

Thus, utilizing the methods of re-contouring lobe tips of gerotor sets as presented in the teachings of the eighth, ninth and tenth alternate preferred embodiments of the present invention achieves the desired goal of providing re-contoured tip portions of lobes of gerotor sets in order to economically achieve preferred diametral clearance values of 0.0005 to 0.001 inch between the critical lobe-to-lobe and lobe-to-groove contact points and thus enable utilization thereof in high-pressure gerotor pumps.

Having described the invention, however, many modifications thereto will become immediately apparent to those skilled in the art to which it pertains, without deviation from the spirit of the invention. For instance, in the case of any gerotor pump 100, 130, 150, 180 or 230 intended for low speed operation, a needle bearing (not shown) could be utilized for supporting the outer rotor 18. Or keys located in slots could be used instead of the pins 134 in the gerotor pump 130. Or an angular position constraint comprising a housing mounted pin and pumping cartridge slot could be used instead of the ends 382 of the pins 380 for providing the reaction torque necessary to support applied motor torque in the universal gerotor pump 370. Further, the exemplary stand-gerotor gerotor pump 400 could have been implemented by simply configuring the exemplary gerotor pump 310 with needle bearings disposed on either side of its gerotor set within the housing 314 and cover plate 330. Or alternately, the exemplary gerotor pump 310 could have been implemented by utilizing a separate housing formed similarly to housing 410 utilized in the exemplary stand-alone gerotor pump 400 and affixed to the motor end bell 316 at the plane of the shoulder 324. And of course, any of the gerotor pumps described herein can also be utilized as a hydraulic motor and could have been so described. All such modifications fall within the scope of the invention.

### Industrial Applicability

The instant gerotor pumps preferably comprising gerotor sets with re-contouring tip regions according to the methods described above are capable of providing improved high-pressure fluid delivery at significantly reduced costs for a wide range of applications, and accordingly find industrial application in various industries both in America and abroad.

1. An improved gerotor pump of the type having a gerotor set comprising an inner rotor having N outwardly extending lobes with N approximately circularly shaped grooves therebetween being in mesh with and, in response to rotational motion of a drive shaft, rotationally driving an eccentrically disposed outer rotor about an eccentricity offset rotation axis, the outer rotor being formed with N+1 inwardly extending circularly shaped elements whereby N+1 pumping chambers are formed between the inwardly and outwardly extending circularly shaped elements and lobes and one groove of the inner rotor, a housing, a gerotor cavity comprised within the housing, a cover plate, a gerotor cavity formed by inner surfaces of the housing and cover plate, housing ports, and axially oriented fluid commutation ports fixedly located on respective inlet and outlet sides of the gerotor pump in a symmetrical manner about a preferred eccentricity axis in at least one of first and second sides of the gerotor cavity for selectively conveying fluid between the housing ports and the pumping chambers, wherein the improvement comprises:
the outer rotor being laterally constrained but allowed to float in an orthogonal direction whereby the actual eccentricity offset rotation axis location is determined by mesh of the gerotor set itself.

2. The improved gerotor pump of claim 1 wherein the N+1 inwardly extending circularly shaped elements are N+1 inwardly extending circularly shaped lobes.

3. The improved gerotor pump of claim 1 wherein the N+1 inwardly extending circularly shaped elements are N+1 inwardly extending rolls.

4. The improved gerotor pump of claim 1 wherein the outer rotor is constrained laterally by a cam follower laterally disposed with respect to the eccentricity axis.

5. The improved gerotor pump of claim 4 wherein the cam follower is an eccentrically adjustable cam follower whereby the operative lateral position of the floating ring can be adjusted.

6. The improved gerotor pump of claim 1 wherein the outer rotor is constrained laterally by first and second cam followers laterally disposed to either side of the eccentricity axis.

7. A first improved method for supporting a gerotor set comprised in a gerotor pump, wherein the method comprises the steps of:
locating the outer rotor of a gerotor set laterally with reference to a preferred eccentricity axis of the gerotor pump; and
allowing the outer rotor to find its own eccentricity offset rotation axis location via mesh of the gerotor set itself.

8. The improved gerotor pump of claim 1 wherein the outer rotor is located within a floating ring and the floating ring is laterally constrained but allowed to float in the orthogonal direction whereby the actual eccentricity offset rotation axis location is determined by mesh of the gerotor set itself.

9. The improved gerotor pump of claim 8 wherein the N+1 inwardly extending circularly shaped elements are N+1 inwardly extending circularly shaped lobes, and radial passages are formed connecting each groove located between the inwardly extending circularly shaped lobes and the outside circular surface of the outer rotor.

10. The improved gerotor pump of claim 9 wherein the radial passages are implemented as radial face slots.

11. The improved gerotor pump of claim 8 wherein the N+1 inwardly extending circularly shaped elements are N+1 inwardly extending rolls.

12. The improved gerotor pump of claim 8 wherein radial holes are formed through the outer rotor between the inwardly extending circularly shaped elements.

13. The improved gerotor pump of claim 8 wherein the floating ring is located laterally with respect to the eccentricity axis by minimal lateral clearance between the floating ring and laterally disposed flat surfaces of the gerotor pocket.

14. The improved gerotor pump of claim 13 wherein the floating ring is precluded from rotation via opposing flat surfaces formed on the periphery of the floating ring slidingly engaging the laterally disposed flat surfaces formed within the modified gerotor pocket.

15. The improved gerotor pump of claim 13 wherein the floating ring is precluded from rotation via engagement of a radially oriented slot formed in the periphery thereof with a housing mounted pin.

16. The improved gerotor pump of claim 8 wherein the floating ring is located laterally by first and second housing mounted lateral positioning means disposed generally along the eccentricity axis in the gerotor pocket engaging slots formed in opposite sides of the floating ring.

17. The improved gerotor pump of claim 8 wherein the floating ring is located laterally by a single pin fixedly mounted in the housing via the pin engaging a hole formed in the floating ring in a laterally protruding portion thereof.

18. The improved gerotor pump of claim 17 wherein the pin is an adjustable eccentric pin whereby the lateral position of the floating ring can be adjusted.

19. A second improved method for supporting a gerotor set comprised in a gerotor pump, wherein the method comprises the steps of:
locating the outer rotor of a gerotor set within a floating ring;
locating the floating ring laterally with reference to a preferred eccentricity axis of the gerotor pump; and
allowing the outer rotor located within the floating ring to find its own eccentricity offset rotation axis location via mesh of the gerotor set itself.

20. The improved gerotor pump of claim 10 wherein the axially oriented fluid commutation ports are curved slot shaped fluid commutation ports whose centerlines are located concentrically with the outer rotor, further wherein the curved slot fluid commutation ports are formed in such a manner that they interdict only with the radial face slots, and still further wherein the curved slot shaped fluid commutation port end spacing is equal to the width of the radial face slots.

21. The improved gerotor pump of claim 10 wherein face fluid commutation ports formed in the floating ring are utilized in place of the axially oriented fluid commutation ports, further wherein the face fluid commutation ports are formed in such a manner that they interdict only with the radial face slots, and still further wherein the face fluid commutation port end spacing is equal to the width of the radial face slots.

22. The improved gerotor pump of claim 11 wherein the axially oriented fluid commutation ports are curved slot shaped fluid commutation ports whose centerlines are located concentrically with the outer rotor, further wherein the curved slot fluid commutation ports are formed in such a manner that they interdict only with the rolls, and still further wherein the curved slot shaped fluid commutation port end spacing is equal to the spacing between the rolls.

23. An improved method for conveying fluid into and out of pumping chambers of a gerotor pump, wherein the method comprises the steps of:
implementing radial passages in the outer rotor of a gerotor set;
implementing fluid commutation ports interdicting only the radial passages; and
utilizing movement of the radial passages over the ends of the fluid commutation ports for switching pumping chamber fluid connection from one fluid commutation port to the other.

24. The improved gerotor pump of claim 1 wherein at least one pressure balancing plate large enough to substantially cover the outer rotor is urged toward the gerotor set in the axial direction thereby limiting face leakage.

25. The improved gerotor pump of claim 8 wherein the floating ring is formed selectively thicker than the gerotor set, and further wherein at least one pressure balancing plate large enough to substantially cover the floating ring is urged into axial contact with the floating ring thereby permitting the gerotor set to operate without any drag at a selected value of axial clearance.

26. An improved gerotor pump of the type having a gerotor set comprising an inner rotor having N outwardly extending lobes with N approximately circularly shaped grooves therebetween being in mesh with and, in response to rotational motion of a drive shaft, rotationally driving an eccentrically disposed outer rotor about an eccentricity offset rotation axis, the outer rotor being formed with N+1 inwardly extending circularly shaped elements whereby N+1 pumping chambers are formed between the inwardly and outwardly extending circularly shaped elements and lobes and one groove of the inner rotor, a housing and cover plate together comprising an enclosed cavity, and housing ports, wherein the improvement comprises:
the gerotor set being located within a floating ring and between pressure balancing plates wherein the gerotor set, floating ring, pressure balancing plates and an axle are combined in an independent pumping cartridge and further wherein the axle is supported for rotation within the pressure balancing plates and in turn supports the inner rotor;
wherein the inner surfaces of the pressure balancing plates are the first and second sides of a gerotor cavity;
wherein fluid commutation ports are provided on respective inlet and outlet sides of the gerotor pump in a symmetrical manner about a preferred eccentricity axis and in fluid communication with the housing ports for selectively conveying fluid between the housing ports and the pumping chambers;
wherein the floating ring is formed selectively thicker than the gerotor set thereby permitting the gerotor set to operate substantially without drag at a selected value of axial clearance when the pressure balancing plates are urged into axial contact with the floating ring;
wherein the outer rotor is laterally constrained but allowed to float in the orthogonal direction; and
further wherein the entire pumping cartridge is allowed to float with reference to the drive shaft.

27. The improved gerotor pump of claim 26 wherein the independent pumping cartridge is rotationally located within the housing by a two degree of freedom coupling in order to support applied motor torque.

28. The improved gerotor pump of claim 27 wherein the two degree of freedom coupling comprises the independent pumping cartridge being located laterally within an intermediate ring whereby the independent pumping cartridge is laterally constrained therewithin but allowed to float in an orthogonal direction, wherein the two degree of freedom coupling further comprises the intermediate ring being orthogonally located within the housing whereby the intermediate ring is orthogonally constrained therewithin but allowed to float in the lateral direction, and further wherein interfacing flat surfaces are universally utilized on the floating ring, pressure balancing plates, intermediate ring and housing.

29. The improved gerotor pump of claim 26 wherein the independent pumping cartridge is rotationally constrained by an offset angular position constraint in order to provide reaction torque necessary to support applied motor torque.

30. The improved gerotor pump of claim wherein the floating ring and pressure balancing plates are laterally constrained with respect to one another by a pin engaging holes formed in the floating ring and pressure balancing plates, and further wherein the offset angular position constraint comprises one or both ends of the pin engaging at least one radially directed oblong slot formed in either or both of the gerotor pocket and the cover plate whereby the floating ring and outer rotor are laterally constrained with respect to the pressure balancing plates but allowed to float in the orthogonal direction.

31. A third improved method for supporting a gerotor set comprised in a gerotor pump, wherein the method comprises the steps of:
locating the inner rotor of a gerotor set between first and second pressure balancing plates;
locating the outer rotor of the gerotor set within a floating ring;
locating the floating ring between the first and second pressure balancing plates and laterally with reference to the inner rotor whereby an independent pumping cartridge comprising the gerotor set floating ring, the first pressure balancing plate and the second pressure balancing plate is formed;
rotationally driving the inner rotor via rotationally driving engagement of the inner rotor with a drive shaft;
providing a rotational constraint for the independent pumping cartridge;
allowing the outer rotor to find its own eccentricity offset rotation axis location with reference to the axis of rotation of the inner rotor via mesh of the gerotor set itself; and
allowing the independent pumping cartridge as a whole to find its own operational position within its rotational constraint via rotational driving engagement of the inner rotor with the drive shaft.

32. A method for re-contouring tip regions of lobes of inner rotors, wherein the method comprises the steps of:
initially forming tip regions of outwardly extending lobes of the inner rotors in a slightly enlarged manner;
positioning each inner rotor within an enlarged lapping tool otherwise shaped like an outer rotor to form lapping gerotor sets; and
progressively deforming the enlarged lapping tools such that they make contact with the tip regions of the outwardly extending lobes of the inner rotors while concomitantly lapping the tip regions of each inner rotor.

33. A method for re-contouring tip regions of lobes of outer rotors, wherein the method comprises the steps of:
initially forming tip regions of inwardly extending lobes of the outer rotors in a slightly enlarged manner;
positioning each outer rotor around a contracted lapping tool otherwise shaped like an inner rotor to form second lapping gerotor sets; and
progressively deforming the outer rotors such that tip regions of their inwardly extending lobes make contact with the contracted lapping tools while concomitantly lapping tip regions of the inwardly extending lobes of the outer rotors until the second and mating preferred size thereof is obtained.

34. A method for forming conjugately-generated tip regions of lobes of inner and outer rotors utilized in gerotor sets, wherein the method comprises the steps of:
initially forming either or both of tip regions of outwardly extending lobes of the inner rotors and inwardly extending lobes of the outer rotors in a slightly enlarged manner;
forcibly distorting each outer rotor by externally applying compressive force along a lateral axis just sufficiently for the provision of assembly clearance for an inner rotor therewithin along an eccentricity axis orthogonally disposed with reference to the lateral axis;
positioning an inner rotor eccentrically along the eccentricity axis within each outer rotor to form the gerotor sets; and
progressively relaxing the externally applied compressive force while concomitantly lapping tip regions of the outwardly extending lobes of the inner rotor and the inwardly extending lobes of the outer rotor of each gerotor set.

35. The improved method of claim 34 further comprising the steps of:
applying inward radial force to the outer rotors to forcibly determine orientation of the eccentricity axes for the gerotor sets;
immersing the gerotor sets in or by a fine lapping slurry; and
rotationally driving each gerotor set as the lateral compressive force is relaxed whereby orthogonal compressive force derived from remaining stress present in the outer rotor along the eccentricity axis is imposed upon the tip regions of the inwardly extending lobes of the outer rotor and the outwardly extending lobes of the inner rotor, thereby lapping tip regions of the inwardly extending lobes of the outer rotor and the outwardly extending lobes of the inner rotor until both the externally applied compressive force and remaining stress in the outer rotors are relaxed and tip region clearance related to the size of the particles in the fine lapping slurry is obtained.

36. The improved method of claim 34 further comprising the steps of:
applying inward radial forces to the outer rotors to forcibly determine orientation of eccentricity axes for the gerotor sets;
immersing the distorted gerotor sets in of by a fine lapping slurry; and
holding each inner or outer rotor in a fixed position and orbitally driving the other rotor by rotating the lateral and eccentricity axes thus forcing the other rotor to orbit as the lateral compressive force is relaxed whereby orthogonal compressive force derived from remaining stress present in the outer rotor along the eccentricity axis is imposed upon the tip regions of the inwardly extending lobes of the outer rotor and the outwardly extending lobes of the inner rotor, thereby lapping tip regions of the inwardly extending lobes of the outer rotor and the outwardly extending lobes of the inner rotor until both the externally applied compressive force and remaining stress in the outer rotor are relaxed and tip region clearance related to the size of the particles in the fine lapping slurry is obtained.

37. A method for “zone” size re-contouring tip regions of lobes of inner rotors for matching outer rotors formed in a standard manner, wherein the method comprises the steps of:
determining the radial location of the tip apexes of the inwardly extending lobes of each outer rotor;
consigning each outer rotor into one of a range of “zone” size determined batches;
initially forming tip regions of outwardly extending lobes of each inner rotor in a slightly enlarged manner;
positioning each inner rotor within an enlarged lapping tool otherwise shaped like an outer rotor to form lapping gerotor sets; and
progressively deforming the enlarged lapping tools such that they make contact with the tip regions of the outwardly extending lobes of the inner rotors while concomitantly lapping the tip regions of each inner rotor until matching “zone” size determined batches are obtained.

38. The improved method of claim 37 further comprising the steps of:
applying inward radial forces to the enlarged lapping tools to forcibly determine orientation of eccentricity axes for the first lapping gerotor sets;
immersing the lapping gerotor sets in or by a lapping slurry; and
rotationally driving each lapping gerotor set while progressively deforming the enlarged lapping tools via lesser radial forces applied along the eccentricity axes from the opposite sides of the enlarged lapping tools such that they make contact with the tip regions of the outwardly extending lobes of the inner rotors thereby lapping the tip regions thereof until they are re-contoured into the matching “zone” size determined batches.

39. The improved method of claim 37 further comprising the steps of:
applying inward radial forces to the enlarged lapping tools to forcibly determine orientation of eccentricity axes for the first lapping gerotor sets;
immersing the lapping gerotor sets in or by a fine lapping slurry; and
holding each inner rotor or enlarged lapping tool in a fixed position and respectively orbitally driving its enlarged lapping tool or inner rotor by rotating the eccentricity axes thus forcing the respective inner rotor or enlarged lapping tool to orbit while progressively deforming the enlarged lapping tools via lesser radial forces applied along the eccentricity axes from the opposite sides of the enlarged lapping tools such that they make contact with the tip regions of the outwardly extending lobes of the inner rotors thereby lapping the tip regions thereof until they are re-contoured into matching “zone” size determined batches.

40. A method for re-contouring tip regions of inner and outer rotors in conformity with standardized first and second preferred sizes, wherein the method comprises the steps of:
initially forming either or both of tip regions of outwardly extending lobes of each inner rotor and the inwardly extending lobes of each outer rotor in a slightly enlarged manner;
positioning each inner rotor within an enlarged lapping tool otherwise shaped like an outer rotor to form first lapping gerotor sets;
progressively deforming the enlarged lapping tools such that they make contact with tip regions of the outwardly extending lobes of the inner rotors while concomitantly lapping tip regions of the outwardly extending lobes of the inner rotors until the first preferred size thereof is obtained;
positioning each outer rotor around a contracted lapping tool otherwise shaped like an inner rotor to form second lapping gerotor sets; and
progressively deforming the outer rotors such that tip regions of their inwardly extending lobes make contact with the contracted lapping tools while concomitantly lapping tip regions of the inwardly extending lobes of the outer rotors until the second and mating preferred size thereof is obtained.

41. The improved method of claim 40 further comprising the steps of:
applying inward radial forces to the enlarged lapping tools and the outer rotors to respectively forcibly determine orientation of eccentricity axes for the first and second lapping gerotor sets;
immersing the first and second lapping gerotor sets in or by a fine lapping slurry;
rotationally driving the first lapping gerotor sets while deforming the enlarged lapping tools via lesser radial forces applied along their eccentricity axes from the opposite sides thereof such that they make contact with the tip regions of the outwardly extending lobes of the inner rotors thereby lapping the tip regions thereof until they are re-contoured into the first preferred size; and
rotationally driving the second lapping gerotor sets while deforming the outer rotors via lesser radial forces applied along their eccentricity axes from the opposite sides of the outer rotors such that the tip regions of their inwardly extending lobes make contact with the contracted lapping tools thereby lapping the tip regions of the inwardly extending lobes until they are re-contoured into the second preferred size.

42. The improved method of claim 40 further comprising the steps of:
applying inward radial forces to the enlarged lapping tools and the outer rotors to respectively forcibly determine orientation of eccentricity axes for the first and second lapping gerotor sets;
immersing the first and second lapping gerotor sets in or by a fine lapping slurry;
holding each inner rotor or enlarged lapping tool in a fixed position and respectively orbitally driving its enlarged lapping tool or inner rotor by rotating the eccentricity axes thus forcing the respective enlarged lapping tool or inner rotor to orbit while deforming the enlarged lapping tools via lesser radial forces applied along their eccentricity axes from the opposite sides thereof such that they make contact with the tip regions of the outwardly extending lobes of the inner rotors thereby lapping the tip regions thereof until they are re-contoured into the first preferred size; and
holding each contracted lapping tool or outer rotor in a fixed position and respectively orbitally driving its outer rotor or contracted lapping tool by rotating the eccentricity axes thus forcing the respective outer rotor or contracted lapping tool to orbit while deforming the outer rotors via lesser radial forces applied along their eccentricity axes from the opposite sides of the outer rotors such that the tip regions of their inwardly extending lobes make contact with the contracted lapping tools thereby lapping the tip regions of the inwardly extending lobes until they are re-contoured into the second preferred size.
